(19) United States
(12) Patent Application Publication
(10) Pub. No.: US 2023/0252498 A1
(43) Pub. Date: Aug. 10, 2023

(54) METHODS AND APPARATUS TO ESTIMATE MEDIA IMPRESSIONS AND DUPLICATION USING COHORTS

(71) Applicant: The Nielsen Company (US), LLC, New York, NY (US)

(72) Inventor: Imran Hirani, Northbrook, IL (US)

(21) Appl. No.: 17/855,121

(22) Filed: Jun. 30, 2022

Related U.S. Application Data
(60) Provisional application No. 63/306,871, filed on Feb. 4, 2022.

(51) Int. Cl. G06Q 30/02

(52) U.S. Cl. CPC G06Q 30/0201

(57) ABSTRACT

An example apparatus includes at least one memory, instructions in the apparatus, and processor circuitry to execute the instructions to access cohort-level impression data corresponding to accesses to media via a plurality of client devices, determine an average cohort-level reach for ones of the a plurality of users corresponding to the client devices, determine a reach probability for a first user of the plurality of users based on the average cohort-level reach for the first user and a census-level reach, and generate a report including the reach probability for the first user.

### RELATED APPLICATION

This patent arises from a patent application that claims the benefit of U.S. Provisional Patent Application No. 63/306,871, which was filed on Feb. 4, 2022. U.S. Provisional Patent Application No. 63/306,871 is hereby incorporated herein by reference in its entirety. Priority to U.S. Provisional Patent Application No. 63/306,871 is hereby claimed.

### FIELD OF THE DISCLOSURE

This disclosure relates generally to computer-based audience measurement and, more particularly, to methods and apparatus to estimate media impressions and duplication using cohorts.

### BACKGROUND

Media is accessible to users through a variety of platforms. For example, media can be viewed on television sets, via the Internet, on mobile devices, in-home or out-of-home, live or time-shifted, etc. Understanding consumer-based engagement with media within and across a variety of platforms (e.g., television, online, mobile, and emerging) allows media providers and website developers to increase user engagement with their media.

### BRIEF DESCRIPTION OF THE DRAWINGS

FIG. 1 is an example system to collect logged impressions from multiple database proprietors and to estimate audience impressions and duplication from the impressions using cohorts.

FIG. 2 is a block diagram of the example audience metrics generator circuitry of FIG. 1.

FIG. 3 is a table illustrating example average cohort-level reach measures for reached and unreached users for different media having different census reaches.

FIG. 4 is an example bar graph illustrating numbers of cohorts by cohort-level reach for media having 20 percent census reach.

FIG. 5 is an example table illustrating users segmented by a number of the user's cohorts having a reach exceeding the census reach for a plurality of cohort iteration examples.

FIG. 6 is a graph illustrating example comparisons of cohort-level reach measures between a first media publisher and a second media publisher.

FIG. 7 is a flowchart representative of example machine readable instructions and/or example operations that may be executed by example processor circuitry to implement the audience metrics generator circuitry of FIG. 2 to determine reach probability.

FIG. 8 is a flowchart representative of example machine readable instructions and/or example operations that may be executed by example processor circuitry to implement the audience metrics generator circuitry of FIG. 2 to determine user-level audience metrics.

FIG. 9 is a flowchart representative of example machine readable instructions and/or example operations that may be executed by example processor circuitry to implement the audience metrics generator circuitry of FIG. 2 to determine deduplicated reach probability.

FIG. 10 is a flowchart representative of example machine readable instructions and/or example operations that may be executed by example processor circuitry to implement the audience metrics generator circuitry of FIG. 2 to determine deduplicated audience metrics.

FIG. 11 is a flowchart representative of example machine readable instructions and/or example operations that may be executed by example processor circuitry to implement the graph generator circuitry of FIG. 2 to generate a duplication plot.

FIG. 12 is a block diagram of an example processing platform including processor circuitry structured to execute the example machine readable instructions and/or the example operations of FIGS. 7-11 to implement the audience metrics generator circuitry of FIG. 2.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIGS. 7-11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Determining a size and demographics of an audience of media helps media providers and distributers schedule programming and determine a price for advertising presented during the programming. In addition, accurate estimates of audience demographics enable advertisers to target advertisements to certain types and/or sizes of audiences. To collect these demographics, an audience measurement entity may enlist a group of media consumers (e.g., a panel of panelists) to cooperate in an audience measurement study. In some examples, the audience measurement entity obtains (e.g., directly, or indirectly from a media service provider) return path data from media presentation devices (e.g., set-top boxes) that identifies tuning data from the media presentation devices. In such examples, because the return path data may not be associated with known panelists, the audience measurement entity models and/or assigns audience members as corresponding to the return path data. In some examples, the media consumption habits and demographic data associated with the enlisted panelists are collected and used to statistically determine the size and demographics of the entire audience of the media presentation. In some examples, this collected data (e.g., data collected via measurement devices) may be supplemented with survey information, for example, recorded manually by audience members.

Techniques for monitoring user access to an Internet-accessible media, such as advertisements and/or content, via digital television, desktop computers, mobile devices, etc. have evolved significantly over the years. Internet-accessible media is also known as digital media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

The inventions disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client requests the media, both the media and the monitoring instructions are downloaded to the client. The monitoring instructions are, thus, executed whenever the media is accessed, be it from a server or from a cache. Upon execution, the monitoring instructions cause the client to send or transmit monitoring information from the client to a content provider site. The monitoring information is indicative of the manner in which content was displayed.

In some implementations, an impression request or ping request can be used to send or transmit monitoring information by a client device using a network communication in the form of a hypertext transfer protocol (HTTP) request. In this manner, the impression request or ping request reports the occurrence of a media impression at the client device. For example, the impression request or ping request includes information to report access to a particular item of media (e.g., an advertisement, a webpage, an image, video, audio, internet content, etc.). In some examples, the impression request or ping request can also include a cookie previously set in the browser of the client device that may be used to identify a user that accessed the media. That is, impression requests or ping requests cause monitoring data reflecting information about an access to the media to be sent from the client device that downloaded the media to a monitoring entity and can provide a cookie to identify the client device and/or a user of the client device. In some examples, the monitoring entity is an audience measurement entity (AME) that did not provide the media to the client and who is a trusted (e.g., neutral) third party for providing accurate usage statistics (e.g., The Nielsen Company, LLC). Since the AME is a third party relative to the entity serving the media to the client device, the cookie sent to the AME in the impression request to report the occurrence of the media impression at the client device is a third-party cookie. Third-party cookie tracking is used by measurement entities to track access to media accessed by client devices from first-party media servers.

There are many database proprietors operating on the Internet. These database proprietors provide services to large numbers of subscribers. In exchange for the provision of services, the subscribers register with the database proprietors. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, Hulu, etc.), etc. These database proprietors set cookies and/or other device/user identifiers on the client devices of their subscribers to enable the database proprietors to recognize their subscribers when they visit their web sites.

The protocols of the Internet make cookies inaccessible outside of the domain (e.g., Internet domain, domain name, etc.) on which they were set. Thus, a cookie set in, for example, the facebook.com domain (e.g., a first party) is accessible to servers in the facebook.com domain, but not to servers outside that domain. Therefore, although an AME (e.g., a third party) might find it advantageous to access the cookies set by the database proprietors, they are unable to do so.

The inventions disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. The inventions disclosed in Mazumdar accomplish this task by structuring the AME to respond to impression requests from client devices (which may not correspond to members of an audience measurement panel and, thus, may be unknown to the AME) by redirecting the client devices from the AME to a database proprietor, such as a social network site partnered with the AME, using an impression response. Such a redirection initiates a communication session between a client device accessing the tagged media and the database proprietor. For example, the impression response received at the client device from the AME may cause the client device to send a second impression request to the database proprietor. In response to the database proprietor receiving this impression request from the client device, the database proprietor (e.g., Facebook) can access any cookie it has set on the client device to thereby identify the client device based on the internal records of the database proprietor. In the event the client device corresponds to a subscriber of the database proprietor, the database proprietor logs/records a database proprietor demographic impression in association with the user/client device.

As used herein, an impression is defined to be an event in which a home or individual accesses and/or is exposed to media (e.g., an advertisement, content, a group of advertisements and/or a collection of content). In Internet media delivery, a quantity of impressions or impression count is the total number of times media (e.g., content, an advertisement, or advertisement campaign) has been accessed by a web population (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

A user of a computing device (e.g., a mobile device, a tablet, a laptop, etc.) and/or a television may be exposed to the same media via multiple devices (e.g., two or more of a mobile device, a tablet, a laptop, etc.) and/or via multiple media types (e.g., digital media available online, digital TV (DTV) media temporality available online after broadcast, TV media, etc.). For example, a user may start watching a particular television program on a television as part of TV media, pause the program, and continue to watch the program on a tablet as part of DTV media. In such an example, the accessing of the program may be logged by an AME twice, once for an impression log associated with the television exposure, and once for the impression request generated by a tag (e.g., census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists or non-panelists) for which an audience measurement entity stores demographic information or can obtain demographic information. Deduplication is a process that is necessary to adjust cross-platform media exposure totals by reducing (e.g., eliminating) the double counting of individual audience members that accessed media via more than one platform and/or are represented in more than one database of media impressions used to determine the reach of the media.

As used herein, a unique audience is based on audience members distinguishable from one another. That is, a particular audience member exposed to particular media is measured as a single unique audience member regardless of how many times that audience member is exposed to that particular media or the particular platform(s) through which the audience member is exposed to the media. If that particular audience member is exposed multiple times to the same media, the multiple exposures for the particular audience member to the same media is counted as only a single unique audience member. In this manner, impression performance for particular media is not disproportionately represented when a small subset of one or more audience members is exposed to the same media an excessively large number of times while a larger number of audience members is exposed fewer times or not at all to that same media. By tracking exposures to unique audience members, a unique audience measure may be used to determine a reach measure to identify how many unique audience members are reached by media. In some examples, increasing unique audience and, thus, reach, is useful for advertisers wishing to reach a larger audience base.

Notably, although third-party cookies are useful for third-party measurement entities in many of the above-described techniques to track media accesses and to leverage demographic information from database proprietors, use of third-party cookies may be limited or may cease in some or all online markets. That is, with fewer or no opportunities to use third-party browser cookies and monitoring instructions in media (e.g., pixel tags), examples disclosed herein mitigate reliance on database proprietor data to measure the demographic distributions of an audience and utilize panel data. However, due to the low sample size of audience members in the panel, not all media accesses can be covered by the panel data.

Examples disclosed herein may be used to estimate user-level media accesses (e.g., media impressions) and duplication using cohort-level impression data. As used herein, a cohort is a group of audience members. Audience members may be grouped into different cohorts randomly and/or based on one or more criteria. In examples disclosed herein, users included in an AME database can be divided (e.g., randomly) into cohorts for a measurement interval. The users in the AME database can be divided into cohorts multiple times (e.g., 2, 6, 10, etc.) for each measurement interval. In examples disclosed herein, an AME can request cohort-level impression data from one or more media publishers (e.g., database proprietors). The media publishers, also referred to herein as publishers, may collect user-level media impression data (e.g., media exposure data, frequency of media exposure, etc.) when users of the publisher (e.g., a database proprietor) access media during authenticated sessions established with the publisher. For example, a user may log-in to a website of a publisher to initiate an authenticated session. During the authenticated session, the publisher is able to record media impressions associated with the user. Due to a desire to protect privacies of its users, a publisher may not provide user-level media impression data to an AME. However, the publisher may be more willing to provide impression data aggregated into groups of users (e.g., as cohort-level data). In examples disclosed herein, an AME can define cohorts of users and request cohort-level impression data from one or more publishers. In response to the request, the publisher can aggregate the user-level media impression data into cohort-level impression data and provide the cohort-level impression data to the AME. In examples disclosed herein, the AME can divide users into cohorts multiple times and request the multiple sets of cohort-level impression data from the one or more publishers.

In examples disclosed herein, the cohort-level impression data can be used to estimate user-level media access reach and/or frequency of impressions. For example, a census-level reach can be determined from the cohort-level impression data. Further, an average cohort-level reach for a given user can be determined from the multiple sets of cohort-level impression data for the same measurement interval. The average cohort-level reach for a given user can be compared to the census-level reach to determine a reach probability for the given user. For example, if the average cohort-level reach for the user is higher than the census-level reach, a reach probability for the user is increased. In another example, if the average cohort-level reach for the user is the same or less than the census-level reach, a reach probability for the user is decreased. A reach probability for each user can be determined and compiled. In another example, the process described above can be used to determine a probability of frequency of media accesses for each user. In some examples, after one or more cohort iterations, an expected cohort-level reach can be determined for each cohort based on a composition of each cohort (e.g., the sum of all reach probabilities from all of the users in the cohort). In these examples, in a subsequent iteration, the average cohort-level reach for a user can be compared to the expected cohort-level reach (e.g., instead of the census-level reach) to determine a reach probability for the given user. In another example, such an iterative process can be used to determine a probability of frequency of media exposure for each user.

In examples disclosed herein, the cohort-level impression data can be used to estimate duplication of impressions for the same audience member to media from multiple publishers. The estimated duplication can be used to deduplicate user-level media impression data. In such examples, the AME can request cohort-level impression data from at least two publishers. In these examples, the users included in each cohort are syndicated across each publisher request. The AME can then receive the syndicated cohort-level impression data from the at least two publishers. In examples disclosed herein, for the cohort-level impression data received from a first one of the publishers, the AME can determine a number of cohorts having a given reach percentage (e.g., 0 percent, ten percent, 20 percent, 50 percent, etc.) for each possible cohort-level reach percentage. The number of cohorts having the given reach percentages for each possible cohort-level reach can be used to generate a distribution of cohorts by cohort-level reach for the first publisher. In addition, for the cohorts of a given reach percentage, examples disclosed herein determine an average cohort-level reach for a second publisher. Examples disclosed herein repeat such determination for each reach percentage of the first publisher. A relationship between the cohort-level reach for the first publisher and the average cohort-level reaches for the second publisher can indicate a degree of duplication between the first publisher and the second publisher. The degree of duplication (e.g., duplication rate, duplication probability) can be applied to user-level impression data determined using examples described above to determine deduplicated reach percentages for each user for the first and second publishers.

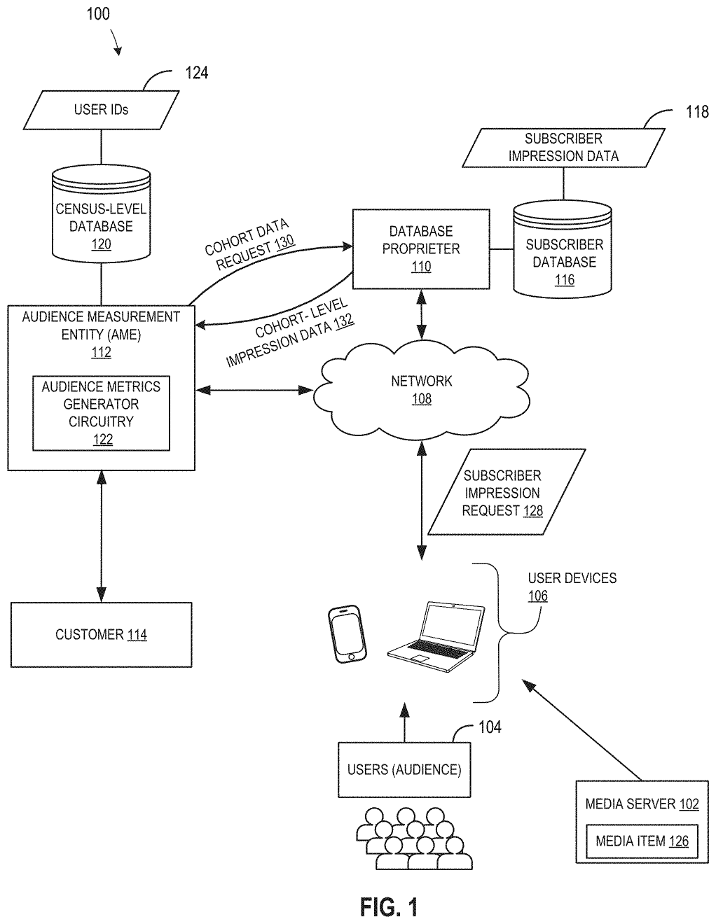

FIG. 1 is a block diagram illustrating an example environment 100 in which example audience metrics generator circuitry 122 is implemented to determine audience metrics or audience measurements such as user-level impression data, user-level impression probabilities, user-level frequency data, user-level frequency probabilities, deduplicated impression data, and/or deduplicated reach probabilities. The example operating environment 100 of FIG. 1 includes an example media server 102, example users 104 (e.g., an audience), example user devices 106, an example network 108, an example database proprietor 110, an example audience measurement entity (AME) 112 and an example customer 114. The example database proprietor 110 includes an example subscriber database 116. The example subscriber database 116 includes example subscriber impression data 118. The example AME 112 includes an example census-level database 120 and example audience metrics generator circuitry 122. The example census-level database 120 includes user identification numbers (IDs) 124. Each of the user IDs 124 can correspond to a unique user. In some examples, the census-level database 120 includes demographic information (e.g., age, gender, location, etc.) corresponding to some or all of the user IDs 124. In some examples, the user IDs 124 may be divided into cohorts. As used herein, a cohort is a group of users, each user identified by a user ID. In some examples, users IDs 124 are randomly assigned to a cohort and each cohort contains the same number of user IDs 124.

In the illustrated example, the example media server 102 serves the media 126 (e.g., a media item 126) to the user devices 106 (e.g., client devices). For example, the media server 102 may serve one or more of different types of media (e.g., movies, songs, advertisements, webpages, e-books, etc. in the form of any one or more of video, audio, images, text, etc.). In some examples, the media server 102 is owned, operated, or affiliated with the database proprietor 110 such that the database proprietor 110 is a media publisher of media (e.g., the media item 126) served by the media server 102. In such examples, accesses to the media item 126 can be tracked by the database proprietor 110 using monitoring techniques that use first-party cookies and/or any other suitable media access monitoring technique. In other examples, the media server 102 is not affiliated with the database proprietor 110 but operates as a media publisher independent from the database proprietor 110 to serve media (e.g., the media item 126) to the user devices 106. In such examples, accesses to the media item 126 can be tracked by the database proprietor 110 using monitoring techniques that use third-party cookies and/or any other suitable third-party media access monitoring technique.

The example users 104 access media on one or more user device(s) 106, such that the occurrence of access and/or exposure to media creates a media impression (e.g., accessing or viewing of an advertisement, a movie, a webpage banner, a webpage, etc.). In the example of FIG. 1, each of the example users 104 are individuals who are subscribers to services provided by the database proprietor 110 and utilize these services via their user device(s) 106. During an authenticated session with the database proprietor 110, some or all of the users 104 access the media item 126 from the media server 102 on respective user devices 106. In example FIG. 1, an impression is logged based on a subscriber impression request 128 (e.g., a request from a known user, a request from a subscriber of the database proprietor 110) by the example database proprietor 110. Such an impression can be stored by the database proprietor 110 in the subscriber impression data 118.

Example user devices 106 (e.g., the client devices 106) can be stationary or portable computers, handheld computing devices, smart phones, Internet appliances, and/or any other type of device that may be capable of accessing media over a network (e.g., the Internet, the network 108, etc.). In the illustrated example of FIG. 1, the user devices 106 include a smartphone (e.g., an Apple iPhone® smartphone, a Motorola® Moto X® smartphone, an Android® smartphone, etc.) and a laptop computer. However, any other type(s) of device(s) may additionally or alternatively be used such as, for example, a tablet (e.g., an Apple iPad® tablet device an Android® tablet device, etc.), a desktop computer, a camera, an Internet compatible television, a smart TV, etc. Examples disclosed herein may be used to collect impression information for any type of media including content and/or advertisements. Media may include advertising and/or content delivered via websites, streaming video, streaming audio, Internet protocol television (IPTV), movies, television, radio and/or any other vehicle for delivering media. In some examples, media includes user-generated media that is, for example, uploaded to media upload sites, such as a YouTube® website, and subsequently downloaded and/or streamed by one or more other client devices for playback. Media may also include advertisements. Advertisements are typically distributed with content (e.g., programming, on-demand video and/or audio). Traditionally, content is provided at little or no cost to the audience because it is subsidized by advertisers that pay to have their advertisements distributed with the content. The user devices 106 of FIG. 1 are used to access (e.g., request, receive, render and/or present) online media provided, for example, by a web server. For example, users 104 can execute a web browser on the user devices 106 to request streaming media (e.g., via an HTTP request) from a media hosting server. The web server can be any web browser used to provide media (e.g., a YouTube® website) that is accessed, through the example network 108, by the example users 104 on example user device(s) 106.

The example network 108 is a communications network that may be implemented using any suitable wired and/or wireless network(s) including, for example, one or more data buses, one or more Local Area Networks (LANs), one or more wireless LANs, a wide area network, a cloud, one or more cellular networks, the Internet, etc. As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events. The example network 108 allows example subscriber impression requests 128 from the example user devices 106 to be received by the example database proprietor 110. In some examples, the user devices 106 communicate with the example network 108 via the Internet.

The example AME 112 operates as an independent party to measure and/or verify audience measurement information relating to media accessed by the users 104. The example AME 112 may report such audience measurement information to the example customer 114. In examples disclosed herein, the AME 112 collects audience measurement information from one or more database proprietors (e.g., the database proprietor 110). However, in order to protect the privacy of the subscribers of the database proprietor 110, the database proprietor 110 may not provide individual user-level subscriber impression data 118 to the AME 112. In examples disclosed herein, the AME 112 may send a cohort data request 130 to the database proprietor 110. The example cohort data request 130 can specify one or more cohorts of user IDs 124 for which the AME 112 is requesting impression data. In response to the cohort data request 130, the example database proprietor 110 can determine subscribers corresponding to the user IDs of the cohort data request 130 and aggregate user-level subscriber impression data 118 into cohort-level impression data 132. For example, the cohort-level impression data 132 can include an aggregated number of impressions for the user IDs 124 included in each cohort. The logged impressions used to generate the aggregate data may represent impressions that were logged for media accesses that occurred during a time period included in the cohort data request 130. The database proprietor 110 can transmit the cohort-level impression data 132 to the AME 112.

The example audience metrics generator circuitry 122 of the AME 112 receives the cohort-level impression data 132. The example audience metrics generator circuitry 122 uses the cohort-level impression data 132 to estimate user-level exposures and/or frequency of exposures to the media item 126. In some examples, the AME 112 receives cohort-level impression data 132 from a plurality of database proprietors 110. In these examples, the cohorts included in the cohort data requests 130 to each of the database proprietors 110 are syndicated such that the user IDs 124 in each cohort are the same for each cohort data request 130. In this manner, the multiple database proprietors provide respective cohort-level impression data 132 based on impressions logged by those database proprietors for the same users corresponding to the user IDs 124. The example audience metrics generator circuitry 122 uses the multiple cohort-level impression data 132 from the plurality of database proprietors 110 to estimate user-level impression duplication. The example AME 112 may output the audience metrics including user-level media impressions, user-level frequencies, deduplicated user-level media impressions, and/or deduplicated user level frequencies to the example customer 114. For example, the AME 112 may send the audience metrics to the example customer 114 as a table or a report.

In examples described herein, the audience metrics generator circuitry 122 of the AME 112 is to execute a syndication process. The audience metrics generator circuitry 122 is to assign users to multiple cohorts. The example audience metrics generator circuitry 122 is to syndicate the cohorts across the first database proprietor (e.g., a first publisher) and the second database proprietor (e.g., a second publisher). The example audience metrics generator circuitry 122 is to request syndicated cohort-level impression data from the first database proprietor and the second database proprietor. The example audience metrics generator circuitry 122 is to determine the duplication probability based on the syndicated cohort-level impression data.

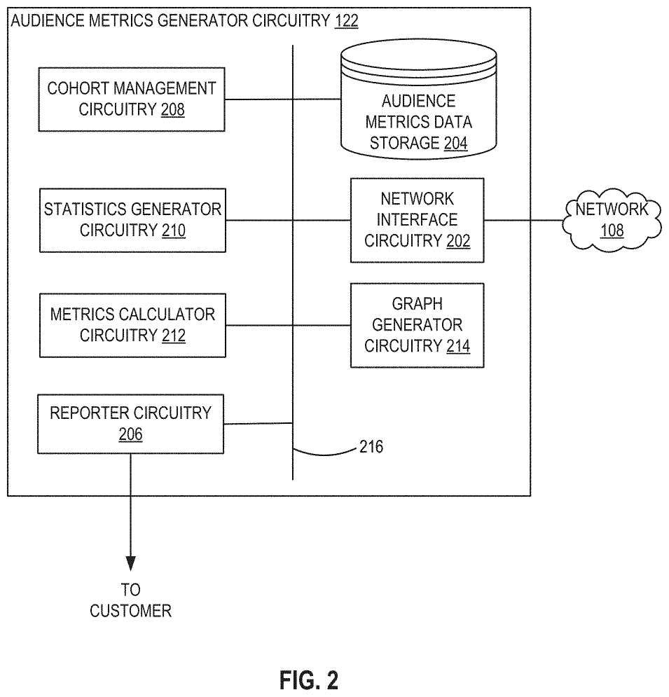

FIG. 2 is a block diagram of the audience metrics generator circuitry 122 to estimate media impressions and impression duplications (e.g., impression duplications represented by multiple logged impressions attributed to the same audience member accessing the same media multiple times). The audience metrics generator circuitry 122 of FIG. 2 may be instantiated (e.g., creating an instance of, bring into being for any length of time, materialize, implement, etc.) by processor circuitry such as a central processing unit executing instructions. Additionally or alternatively, the audience metrics generator circuitry 122 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor.

The example audience metrics generator circuitry 122 includes an example network interface circuitry 202, an example audience metrics data storage 204, example reporter circuitry 206, example cohort management circuitry 208, example statistics generator circuitry 210, example metrics calculator circuitry 212, and example graph generator circuitry 214 all of which are in communication (e.g., by exchanging data via accesses, requesting, and/or loading) by an example bus 216.

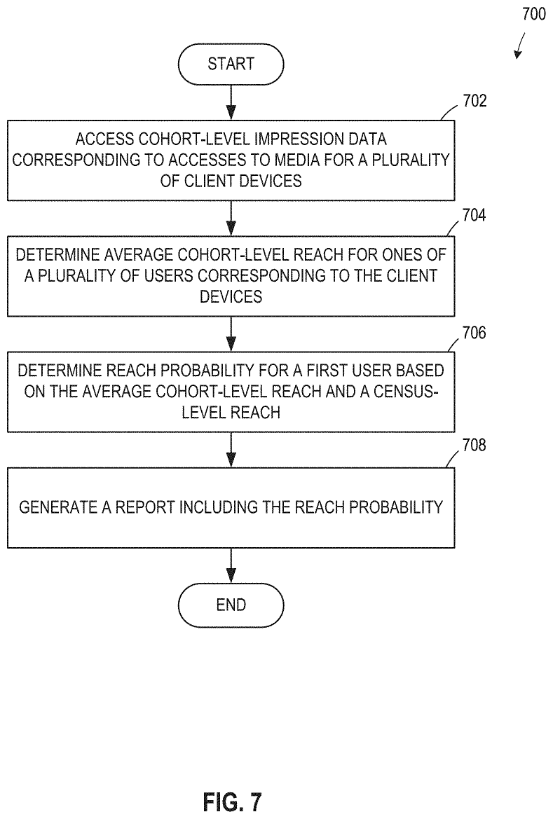

The example network interface circuitry 202 communicates with the example database proprietor 110 (FIG. 1) via the example network 108 (FIG. 1). For example, the network interface circuitry 202 can send the cohort data request 130 (FIG. 1) to the database proprietor 110 via the network 108. Further, the example network interface circuitry 202 can receive access to cohort-level impression data 132 (FIG. 1) from the database proprietor 110 via the network 108. In some examples, the network interface circuitry 202 sends cohort data requests to a plurality of database proprietors. In some of these examples, cohort assignments are syndicated across the cohort data requests to the plurality of database proprietors such that an impression duplication rate between the database proprietors can be determined. In some examples, the network interface circuitry 202 requests the syndicated cohort-level impression data from the first database proprietor and the second database proprietor. In some examples, the network interface circuitry 202 is instantiated by processor circuitry executing network interface instructions and/or configured to perform operations such as those represented by the flowcharts of FIGS. 7-11.

The example audience metrics data storage 204 (e.g., a data store, an audience metrics data store) stores subscriber-based audience metrics data accessed from the database proprietor 110. For example, as the network interface circuitry 202 receives cohort-level impression data 132 from the database proprietor 110, the network interface circuitry 202 can store the cohort-level impression data 132 in the audience metrics data storage 204. The audience metrics data storage 204 may be implemented by any storage device and/or storage disc for storing data such as flash memory, magnetic media, optical media, etc. Furthermore, the data stored in the audience metrics data storage 204 may be in any data format such as binary data, comma delimited data, tab delimited data, structured query language (SQL) structures, etc. While in the illustrated example the audience metrics data storage 204 is illustrated as a single database, the audience metrics data storage 204 can be implemented by any number and/or type(s) of databases. In addition, the example audience metrics data storage 204 need not be a database and may be implemented using any other data storage format.

The example reporter circuitry 206 outputs the user-level audience metrics (e.g., user-level impression data, user-level impression probabilities, user-level frequency data, user-level frequency probabilities, deduplicated impression data, and/or deduplicated reach probabilities) determined by the audience metrics generator circuitry 122. For example, the reporter circuitry 206 may send the user-level audience metrics to a customer (e.g., the customer 114 of FIG. 1). In other examples, the reporter circuitry 206 may store the user-level audience metrics in the audience metrics data storage 204. The example reporter circuitry 206 can compile user-level audience metrics into an audience metrics tables prior to reporting or storing the user-level audience metrics. Further, the example reporter circuitry 206 can generate one or more reports including the user-level audience metrics. In some examples, the reporter circuitry 206 is instantiated by processor circuitry executing reporting instructions and/or configured to perform operations such as those represented by the flowcharts of FIGS. 7-11.

The example cohort management circuitry 208 manages the assignments of users to cohorts. For example, the cohort management circuitry 208 retrieves the user IDs 124 (FIG. 1) from the census-level database 120 (FIG. 1) of the AME 112 (FIG. 1). The example cohort management circuitry 208 can take the user IDs 124 or a subset of the user IDs 124 and assign each of the user IDs 124 randomly into a cohort. For example, the cohort management circuitry 208 can take a subset of 100,000 of the user IDs known to be subscribers of the database proprietor 110 (FIG. 1) and randomly assign the user IDs 124 into 1,000 cohorts having 100 users each. As a result, the cohort management circuitry 208 generates user ID-to-cohort assignments. In some examples, the cohort management circuitry 208 repeats the cohort assignment process a plurality of iterations (e.g., three iterations, ten iterations, etc.) such that each user ID is assigned to a cohort once per iteration and has a number of user ID-to-cohort assignments corresponding to the number of iterations. The example cohort management circuitry 208 can store the user ID-to-cohort assignments in the audience metrics data storage 204. In some examples, the cohort management circuitry 208 is instantiated by processor circuitry executing cohort management instructions and/or configured to perform operations such as those represented by the flowcharts of FIGS. 7-11.

In some examples, the subset of the user IDs assigned to cohorts by the cohort management circuitry 208 are known to be subscribers of a first database proprietor and a second database proprietor. As such, the cohort data request 130 sent to the first database proprietor by the network interface circuitry 202 can have cohorts which are syndicated with a second cohort data request sent to the second database proprietor. In other words, the same user ID-to-cohort assignments are used for requests to both the first database proprietor and the second database proprietor. In this manner, the AME 112 can leverage impressions logged by the different database proprietors for the same audience members. As such, if one of the database proprietors does not have an impression logged for a particular audience member and a particular media item, the AME 112 can leverage a logged impression from the other database proprietor for that audience member and that media item to determine that the audience member did access the media item.

The example statistics generator circuitry 210 generates statistics corresponding to audience metrics data. For example, the statistics generator circuitry 210 can determine statistics relating to the cohort-level impression data 132 accessed by the network interface circuitry 202 from the database proprietor 110. The example statistics generator circuitry 210 can determine a census-level reach of the cohort-level impression data 132. For example, the cohort-level impression data 132 can include a cohort-level reach (e.g., a number of users of the cohort that accessed a media item) of each of the cohorts included in the cohort-level impression data 132. Based on each of the cohort-level reaches and a known size of the cohorts, the example statistics generator circuitry 210 can determine a census-level reach for the cohort-level impression data 132. In some examples, the cohort-level impression data 132 includes a cohort-level frequency (e.g., an aggregated number of times the users included in a cohort accessed a media item) for each of the cohorts. In these examples, the statistics generator circuitry 210 can determine a census-level frequency for the cohort-level impression data based on the cohort-level frequencies and the known size of each of the cohorts. In some examples, the statistics generator circuitry 210 is instantiated by processor circuitry executing statistics generator instructions and/or configured to perform operations such as those represented by the flowcharts of FIGS. 7-11.

The example statistics generator circuitry 210 can determine average cohort-level reach or frequency for a given media item for a user represented in the cohort-level impression data 132. For example, for a given user ID, the statistics generator circuitry 210 can find the cohort-level reach for each cohort to which the user ID is assigned. In the example of 10 cohort iterations, the given user ID is assigned to 10 different cohorts. The example statistics generator circuitry 210 can locate the 10 cohorts within the cohort-level impression data 132 and determine an average cohort-level reach of the 10 cohorts. In other examples, the cohort-level impression data 132 includes cohort-level frequency data and the statistics generator circuitry 210 determines an average cohort-level frequency for a given user (e.g., for ones of the plurality of users corresponding to client devices). The example statistics generator circuitry 210 can determine the average cohort-level reach or the average cohort-level frequency for each of the users included in the cohort-level impression data 132. The example statistics generator 210 determines an estimated frequency for the first user of the plurality of users based on the average cohort-level frequency for the first user of the plurality of users and the census-level frequency.

The example statistics generator circuitry 210 can determine an expected cohort-level reach for each cohort. For example, after one or more cohort iterations, the statistics generator circuitry 210 can determine an expected cohort-level reach for each cohort based on a composition of each cohort (e.g., the sum of all reach probabilities from all of the users in the cohort). In these examples, in a subsequent iteration, the average cohort-level reach for a user can be compared to the expected cohort-level reach (e.g., instead of the census-level reach) to determine a reach probability for the given user. In another example, such an iterative process can be used to determine a probability of frequency of media accesses for each user.

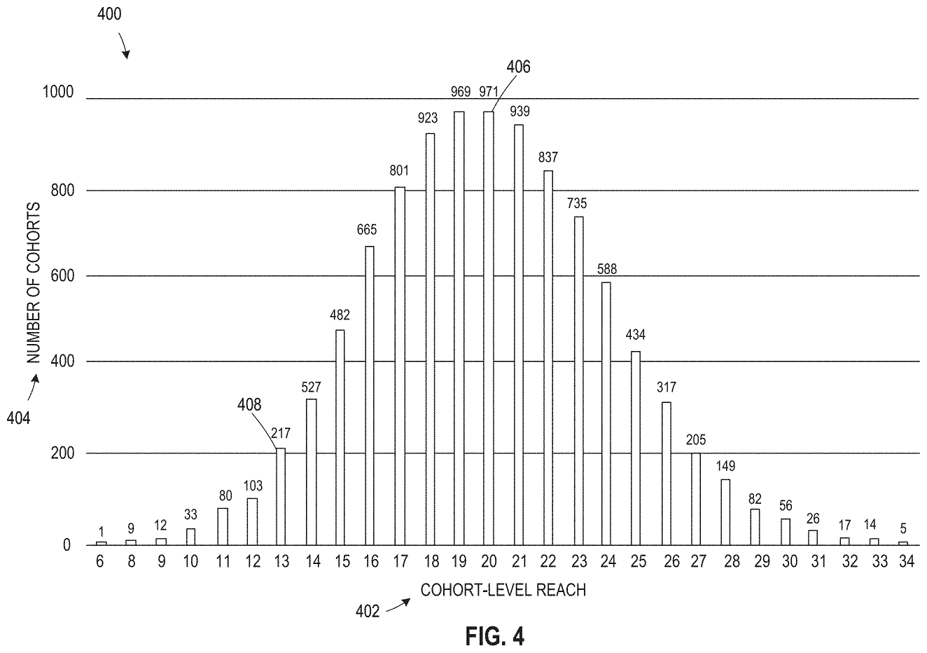

The example statistics generator circuitry 210 can determine a distribution of cohorts by cohort-level reach or frequency for the cohort-level impression data 132. For example, the cohort-level impression data 132 may include cohort-level reach data from a first database proprietor (e.g., a publisher) for 100,000 users divided into 1,000 cohorts of 100 users in a total of 10 iterations, resulting in a total of 10,000 cohorts. Each of the 10,000 cohorts can have a cohort-level reach between 0 and 100. The example statistics generator circuitry 210 can determine a number of cohorts having each possible cohort-level reach between 0 and 100 based on the cohort-level impression data 132. For example, the statistics generator circuitry 210 can determine that 254 cohorts had a cohort-level reach of 14. In some examples, the statistics generator circuitry 210 records the number of cohorts having a given cohort-level reach and which of the cohorts had the given cohort-level reach. Based on the numbers of cohorts having each possible cohort-level reach, the example statistics generator circuitry 210 can determine a distribution of cohorts by cohort-level reach, as discussed further below in connection with FIG. 4.

The example statistics generator circuitry 210 can determine duplication statistics corresponding to a first and a second database proprietor (e.g., a publisher). For example, the statistics generator circuitry 210 can determine a duplication probability between the first database proprietor and the second database proprietor based on a direction and a magnitude of a slope of trendline generated by the graph generator circuitry 214 as described below. The duplication probability, as used herein, refers to a probability or likelihood that there are duplicate impressions for the same media accessed by the same audience member. For example, the duplication probability between the first database proprietor (e.g., a first publisher) and the second database proprietor (e.g., a second publisher) refers to a probability that both the first database proprietor and the second database proprietor recorded an impression for a given audience member having accessed a given item of media. In some examples, the slope of the trendline is zero or approximately zero and the statistics generator circuitry 210 determines the duplication probability to be fair share (e.g., no relationship). In some examples, the direction of the slope of the trendline is positive and the statistics generator circuitry 210 determines that the duplication probability between the first database proprietor and the second database proprietor exceeds fair share duplication. In other examples, the direction of the slope of the trendline is negative and the statistics generator circuitry 210 determines that the duplication probability lags fair share duplication. In some examples, the statistics generator circuitry 210 can determine an amount to which the duplication probability exceeds or lags fair share duplication based on the magnitude of the slope of the trendline. For example, there may be a linear relationship between the magnitude of the slope of the trendline and the amount to which the duplication probability exceeds or lags fair share duplication. The example statistics generator circuitry 210 can determine the amount to which the duplication probability exceeds or lags fair share duplication based on the linear relationship.

The example metrics calculator circuitry 212 can determine user-level audience metrics based on the cohort-level impression data 132. The example metrics calculator circuitry 212 can determine a user-level reach probability based on an expected reach value compared to an average cohort-level reach value for the given user. In some examples, the metrics calculator circuitry 212 accesses a census-level reach of the cohort-level impression data 132 as determined by the statistics generator circuitry 210 to use as the expected reach. In these examples, the metrics calculator circuitry 212 compares an average cohort-level reach for a given user ID as determined by the statistics generator circuitry 210 to the census-level reach to determine a user-level reach probability. Based on the census-level reach and the average cohort-level reach for a given user ID, the example metrics calculator circuitry 212 determines a user-level reach probability for the given user ID. In other examples, the metrics calculator circuitry 212 uses the expected cohort-level reach as calculated by the statistics generator circuitry 210 after one or more cohort iterations as the expected reach value. In some examples, the metrics calculator circuitry 212 determines user-level frequency probabilities. For example, the metrics calculator circuitry 212 can determine the user-level frequency probability based on an expected frequency value compared to an average cohort-level frequency value for the given user. In some examples, the expected frequency value is the census-level frequency of the cohort-level impression data 132 as determined by the statistics generator circuitry 210. In some examples, the metrics calculator circuitry 212 is instantiated by processor circuitry executing metrics calculator instructions and/or configured to perform operations such as those represented by the flowcharts of FIGS. 7-11.

In some examples, if the metrics calculator circuitry 212 determines that a cohort-level reach of any cohort that a user was assigned to was zero, the user-level reach probability for the user is zero. In other words, if there exists a cohort with a cohort-level reach of zero, it is known that each user assigned to that cohort was not reached by the media. Similarly, if the metrics calculator circuitry 212 determines that a cohort-level frequency of any cohort that a user was assigned to was zero, the user-level frequency for the user is zero.

The example metrics calculator circuitry 212 can also determine user-level deduplicated audience metrics. For example, the metrics calculator circuitry 212 can determine a first user-level reach probability for a given user for a first database proprietor (e.g., a publisher) and a second user-level reach probability for the given user for a second database proprietor (e.g., a publisher) using techniques described above. The example metrics calculator circuitry 212 can access a duplication probability between the first database proprietor and the second database proprietor as determined by the statistics generator circuitry 210. Based on the first user-level reach probability, the second user-level reach probability, and the duplication probability, the metrics calculator circuitry 212 can determine a deduplicated reach probability for the user. For example, if the first user-level reach probability is 10 percent and the second user-level reach probability is 20 percent, a maximum combined reach probability is 30 percent while a minimum combined reach probability is 20 percent. However, if the duplication probability is two (e.g., two times fair share), the user has a four percent probability of having been reached by both the first and the second database proprietor. Therefore, the deduplicated reach for the user is 26 percent (e.g., four percent less than the maximum combined reach probability of 30 percent). In other words, there is a 26 percent chance that the user was reached by the media by either the first database proprietor or the second database proprietor.

In some examples, based on the first user-level reach probability A (e.g., a reach probability for a first database proprietor), the second user-level reach probability B (e.g., a reach probability for a second database proprietor), and the duplication probability C, the metrics calculator circuitry 212 is to determine a first deduplicated user-level reach probability (e.g., a deduplicated reach probability for the first database proprietor) X, a second deduplicated user-level reach probability (e.g., a deduplicated reach probability for the second database proprietor) Y, and a duplicated reach probability Z (e.g., across the first database proprietor and the second database proprietor). Example Equation 1 is illustrated below.

X=A−(A*B*C) (Equation 1)

In example Equation 1 above, the metrics calculator circuitry 212 multiplies the first user-level reach probability A by the second user-level reach probability B and the duplication probability C to generate a product. The example metrics calculator circuitry 212 subtracts the product of the multiplication from the first user-level reach probability A to generate the first deduplicated user-level reach probability X.

Y=B−(A*B*C) (Equation 2)

In example Equation 2 above, the metrics calculator circuitry 212 multiplies the first user-level reach probability A by the second user-level reach probability B and the duplication probability C to generate a product. The example metrics calculator circuitry 212 subtracts the product of the multiplication from the second user-level reach probability B to generate the second deduplicated user-level reach probability Y.

Z=A*B*C (Equation 3)

In example Equation 3 above, the metrics calculator circuitry 212 multiplies the first user-level reach probability A by the second user-level reach probability B and the duplication probability C to generate the duplicated reach probability Z. The example duplicated reach probability Z represents duplicated reach probability across the first database proprietor and the second database proprietor. As illustrated with example Equation 1, example Equation 2, and example Equation 3, the metrics calculator circuitry 212 may be used to determine a deduplicated reach probability based on a duplication probability and a reach probability for the plurality of users.

The example graph generator circuitry 214 can generate graphs which can be used to determine duplication statistics between two database proprietors (e.g., publishers). To generate the graphs, the example graph generator circuitry 214 first determines median cohort-level reaches for a second database proprietor based on the distribution of cohorts for the first database proprietor determined by the statistics generator circuitry 210. For example, for each possible cohort-level reach, the statistics generator circuitry 210 determines which cohorts have the given cohort-level reach for the first database proprietor. Subsequently, for each possible cohort-level reach, the graph generator circuitry 214 determines the median cohort-level reach for the second database proprietor for those cohorts identified by the statistics generator circuitry 210. Such process is repeated for each possible cohort-level reach (e.g., from 0 to 100 for cohorts having a size of 100 users). The example graph generator circuitry 214 can store the median cohort-level reaches for the second database proprietor as a function of the cohort-level reach for the first database proprietor. In some examples, the graph generator circuitry 214 is instantiated by processor circuitry executing graph generator instructions and/or configured to perform operations such as those represented by the flowcharts of FIGS. 7-11.

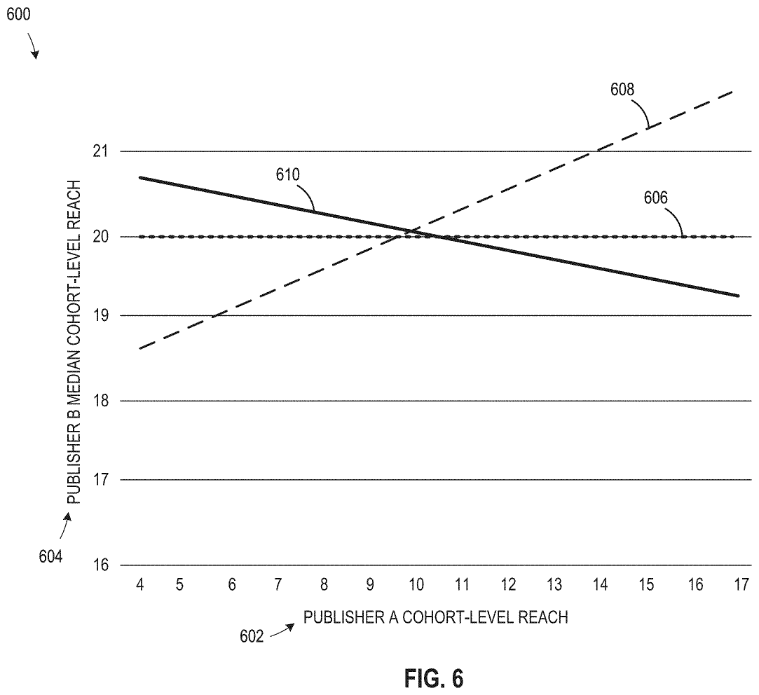

The example graph generator circuitry 214 can generate a graph (e.g., an X-Y scatter plot) of the median cohort-level reaches for the second database proprietor as a function of the cohort-level reach for the first database proprietor. Such an example graph is discussed below in connection with FIG. 6. The example graph generator circuitry 214 can then determine a line of best fit for the scatter plot data. For example, the graph generator circuitry can perform regression analysis to determine a line of best fit (e.g., a trendline) for the scatter plot data. In some examples, the trendline is a linear trendline represented by the equation y=mx+b where m represents a slope of the trendline and b represents a y-intercept of the trendline. The example graph generator circuitry 214 can store the information (e.g., the slope, m, and/or the y-intercept, b) about the trendline.

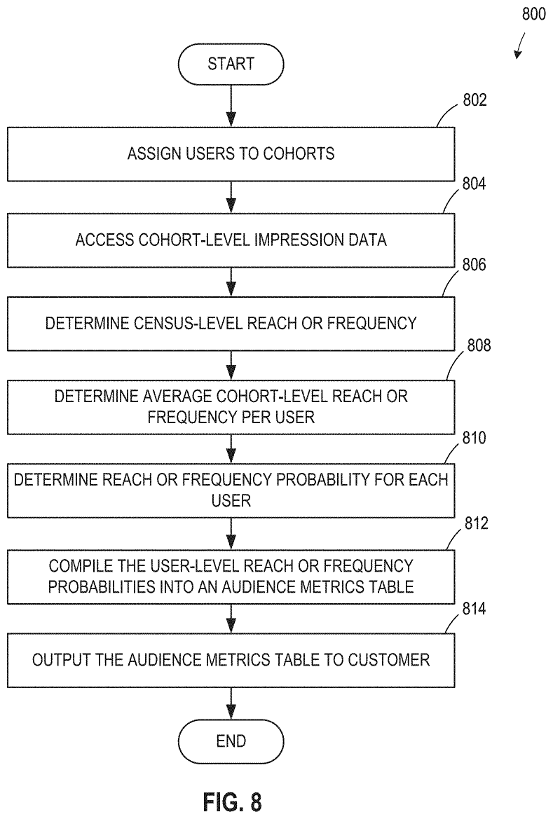

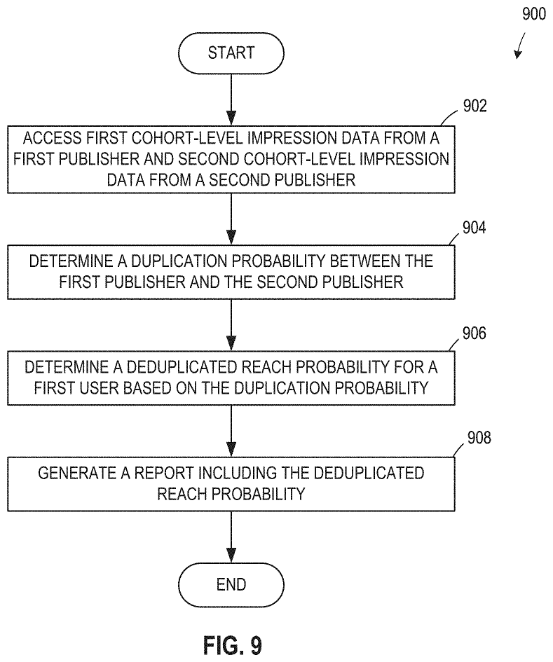

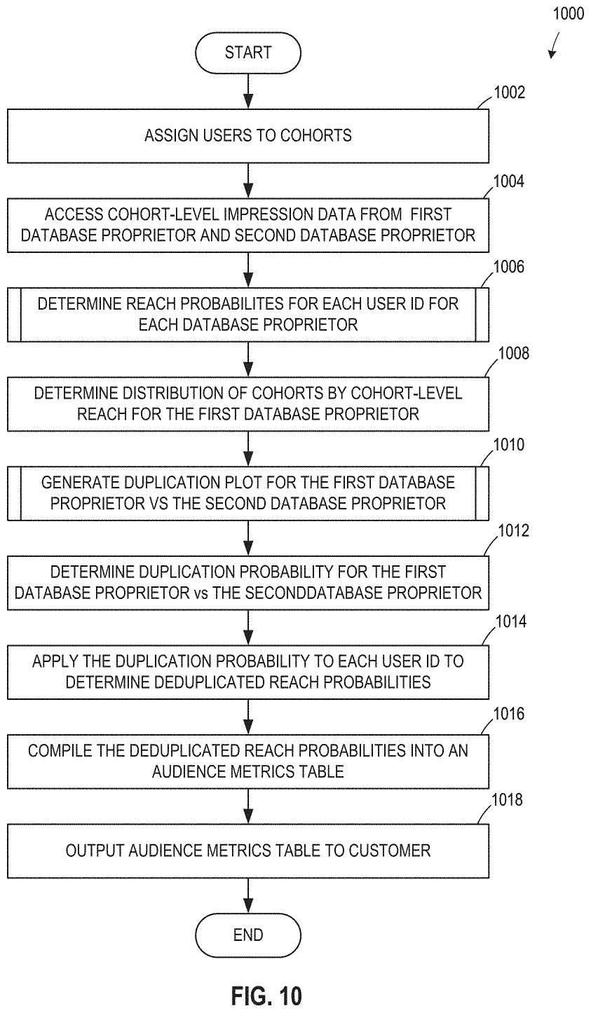

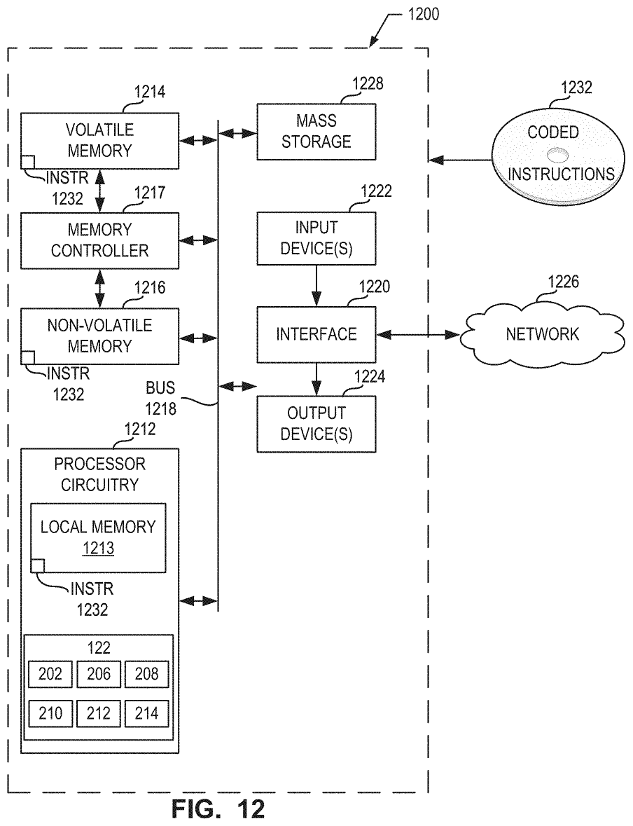

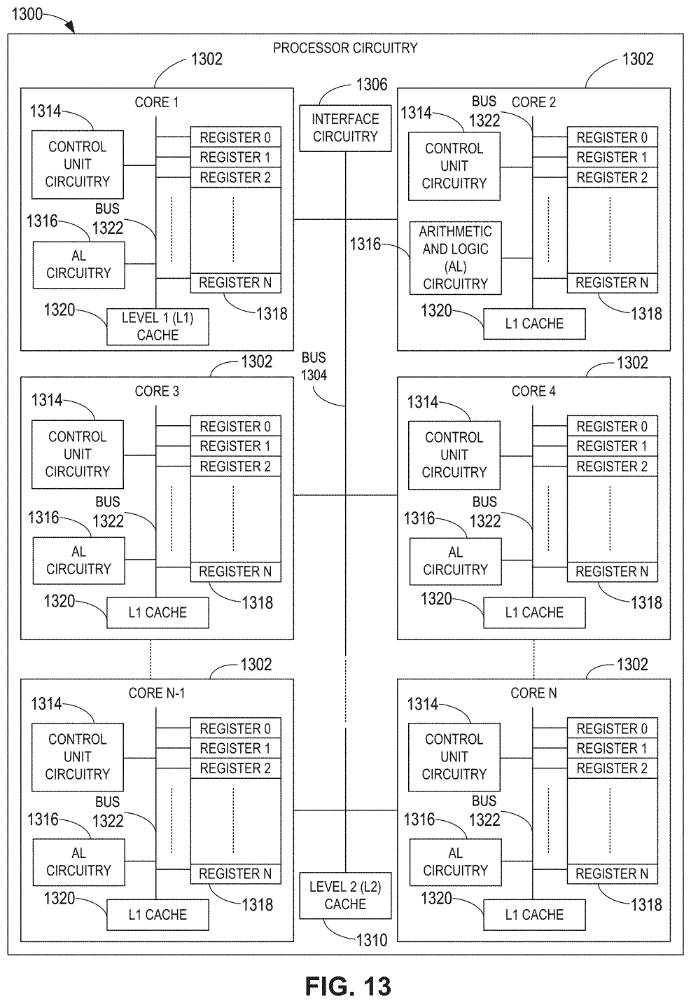

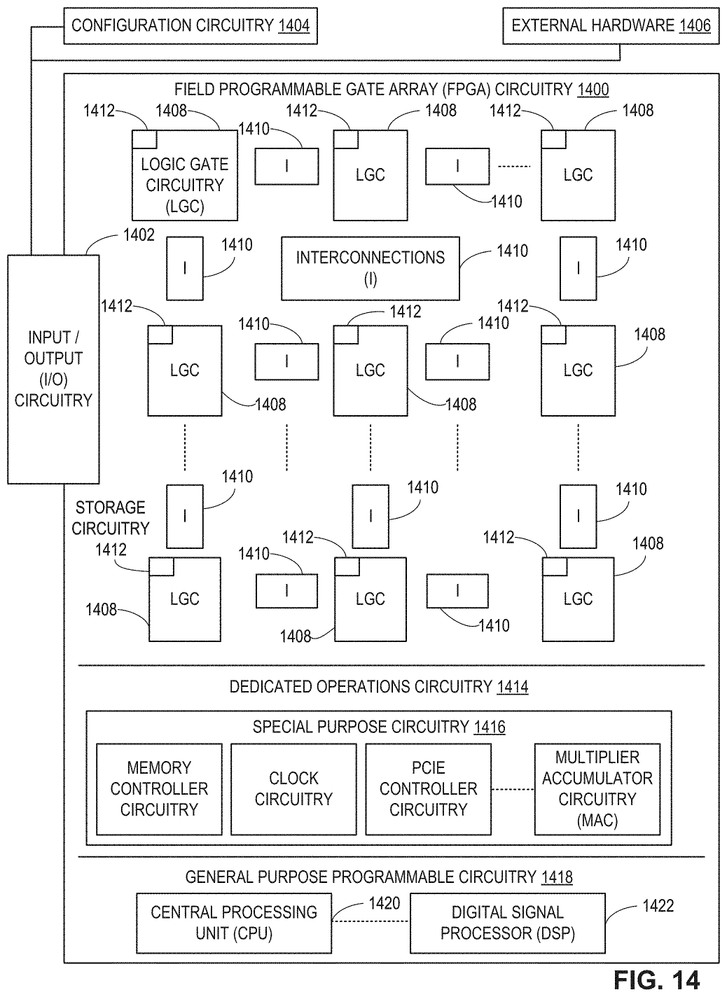

In some examples, the apparatus includes means for accessing cohort-level impression data. For example, the means for accessing cohort-level impression data may be implemented by the network interface circuitry 202. In some examples, the network interface circuitry 202 may be instantiated by processor circuitry such as the example processor circuitry 1212 of FIG. 12. For instance, the network interface circuitry 202 may be instantiated by the example microprocessor 1300 of FIG. 13 executing machine executable instructions such as those implemented by at least blocks 702 of FIG. 7, 804 of FIG. 8, 902 of FIG. 9, and 1004 of FIG. 10. In some examples, the network interface circuitry 202 may be instantiated by hardware logic circuitry, which may be implemented by an ASIC, XPU, or the FPGA circuitry 1400 of FIG. 14 structured to perform operations corresponding to the machine readable instructions. Additionally or alternatively, the network interface circuitry 202 may be instantiated by any other combination of hardware, software, and/or firmware. For example, the network interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for determining an average cohort-level reach. For example, the means for determining an average cohort-level reach may be implemented by the statistics generator circuitry 210. In some examples, the statistics generator circuitry 210 may be instantiated by processor circuitry such as the example processor circuitry 1212 of FIG. 12. For instance, the statistics generator circuitry 210 may be instantiated by the example microprocessor 1300 of FIG. 13 executing machine executable instructions such as those implemented by at least blocks 704 of FIG. 7 and 808 of FIG. 8. In some examples, the statistics generator circuitry 210 may be instantiated by hardware logic circuitry, which may be implemented by an ASIC, XPU, or the FPGA circuitry 1400 of FIG. 14 structured to perform operations corresponding to the machine readable instructions. Additionally or alternatively, the statistics generator circuitry 210 may be instantiated by any other combination of hardware, software, and/or firmware. For example, the statistics generator circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for determining a reach probability. For example, the means for determining a reach probability may be implemented by the metrics calculator circuitry 212. In some examples, the metrics calculator circuitry 212 may be instantiated by processor circuitry such as the example processor circuitry 1212 of FIG. 12. For instance, the metrics calculator circuitry 212 may be instantiated by the example microprocessor 1300 of FIG. 13 executing machine executable instructions such as those implemented by at least blocks 706 of FIGS. 7 and 810 of FIG. 8. In some examples, the metrics calculator circuitry 212 may be instantiated by hardware logic circuitry, which may be implemented by an ASIC, XPU, or the FPGA circuitry 1400 of FIG. 14 structured to perform operations corresponding to the machine readable instructions. Additionally or alternatively, the metrics calculator circuitry 212 may be instantiated by any other combination of hardware, software, and/or firmware. For example, the metrics calculator circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for generating a report. For example, the means for generating a report may be implemented by the reporter circuitry 206. In some examples, the reporter circuitry 206 may be instantiated by processor circuitry such as the example processor circuitry 1212 of FIG. 12. For instance, the reporter circuitry 206 may be instantiated by the example microprocessor 1300 of FIG. 13 executing machine executable instructions such as those implemented by at least blocks 708 of FIG. 7, 812, 814 of FIG. 8, 908 of FIG. 9, and 1016 and 1018 of FIG. 10. In some examples, the reporter circuitry 206 may be instantiated by hardware logic circuitry, which may be implemented by an ASIC, XPU, or the FPGA circuitry 1400 of FIG. 14 structured to perform operations corresponding to the machine readable instructions. Additionally or alternatively, the reporter circuitry 206 may be instantiated by any other combination of hardware, software, and/or firmware. For example, the reporter circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for determining a duplication probability. For example, the means for determining a duplication probability may be implemented by the statistics generator circuitry 210. In some examples, the statistics generator circuitry 210 may be instantiated by processor circuitry such as the example processor circuitry 1212 of FIG. 12. For instance, the statistics generator circuitry 210 may be instantiated by the example microprocessor 1300 of FIG. 13 executing machine executable instructions such as those implemented by at least blocks 904 of FIG. 9, and 1012 of FIG. 10. In some examples, the statistics generator circuitry 210 may be instantiated by hardware logic circuitry, which may be implemented by an ASIC, XPU, or the FPGA circuitry 1400 of FIG. 14 structured to perform operations corresponding to the machine readable instructions. Additionally or alternatively, the statistics generator circuitry 210 may be instantiated by any other combination of hardware, software, and/or firmware. For example, the statistics generator circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for determining a deduplicated reach probability. For example, the means for determining a deduplicated reach probability may be implemented by the metrics calculator circuitry 212. In some examples, the metrics calculator circuitry 212 may be instantiated by processor circuitry such as the example processor circuitry 1212 of FIG. 12. For instance, the metrics calculator circuitry 212 may be instantiated by the example microprocessor 1300 of FIG. 13 executing machine executable instructions such as those implemented by at least blocks 906 of FIG. 9, and 1014 of FIG. 10. In some examples, the metrics calculator circuitry 212 may be instantiated by hardware logic circuitry, which may be implemented by an ASIC, XPU, or the FPGA circuitry 1400 of FIG. 14 structured to perform operations corresponding to the machine readable instructions. Additionally or alternatively, the metrics calculator circuitry 212 may be instantiated by any other combination of hardware, software, and/or firmware. For example, the metrics calculator circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for determining a distribution of cohorts. For example, the means for determining a distribution of cohorts may be implemented by the statistics generator circuitry 210. In some examples, the statistics generator circuitry 210 may be instantiated by processor circuitry such as the example processor circuitry 1212 of FIG. 12. For instance, the statistics generator circuitry 210 may be instantiated by the example microprocessor 1300 of FIG. 13 executing machine executable instructions such as those implemented by at least blocks 1008 of FIG. 10. In some examples, the statistics generator circuitry 210 may be instantiated by hardware logic circuitry, which may be implemented by an ASIC, XPU, or the FPGA circuitry 1400 of FIG. 14 structured to perform operations corresponding to the machine readable instructions. Additionally or alternatively, the statistics generator circuitry 210 may be instantiated by any other combination of hardware, software, and/or firmware. For example, the statistics generator circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

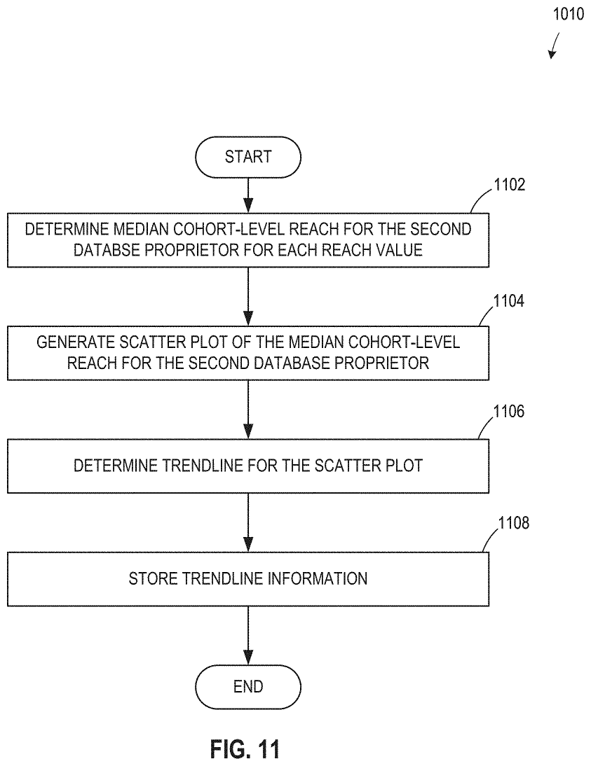

In some examples, the apparatus includes means for generating a duplication plot. For example, the means for generating a duplication plot may be implemented by the graph generator circuitry 214. In some examples, the graph generator circuitry 214 may be instantiated by processor circuitry such as the example processor circuitry 1212 of FIG. 12. For instance, the graph generator circuitry 214 may be instantiated by the example microprocessor 1300 of FIG. 13 executing machine executable instructions such as those implemented by at least blocks 1010 of FIGS. 10 and 1102, 1104, 1106 and 1108 of FIG. 11. In some examples, the graph generator circuitry 214 may be instantiated by hardware logic circuitry, which may be implemented by an ASIC, XPU, or the FPGA circuitry 1400 of FIG. 14 structured to perform operations corresponding to the machine readable instructions. Additionally or alternatively, the graph generator circuitry 214 may be instantiated by any other combination of hardware, software, and/or firmware. For example, the graph generator circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the audience metrics generator circuitry 122 of FIG. 1 is illustrated in FIG. 2, one or more of the elements, processes, and/or devices illustrated in FIG. 2 may be combined, divided, re-arranged, omitted, eliminated, and/or implemented in any other way. Further, the example network interface circuitry 202, the example reporter circuitry 206, the example cohort management circuitry 208, the example statistics generator circuitry 210, the example metrics calculator circuitry 212, the example graph generator circuitry 214, and/or, more generally, the example audience metrics generator circuitry 122 of FIG. 1, may be implemented by hardware alone or by hardware in combination with software and/or firmware. Thus, for example, any of the example network interface circuitry 202, the example reporter circuitry 206, the example cohort management circuitry 208, the example statistics generator circuitry 210, the example metrics calculator circuitry 212, the example graph generator circuitry 214, and/or, more generally, the example audience metrics generator circuitry 122, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example audience metrics generator circuitry 122 of FIG. 1 may include one or more elements, processes, and/or devices in addition to, or instead of, those illustrated in FIG. 2, and/or may include more than one of any or all of the illustrated elements, processes and devices.

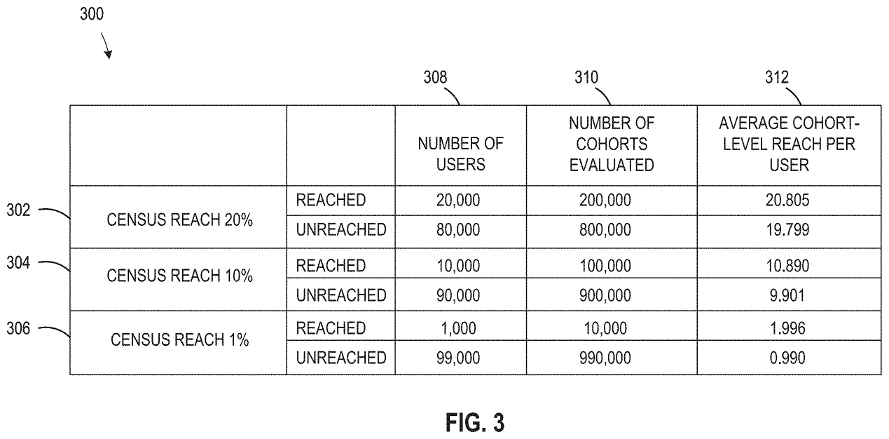

FIG. 3 is a table 300 illustrating example average cohort-level reach for reached and unreached users for different media having different census reaches. The example data illustrated in the table 300 is simulated data for a universe of 100,000 users. Three example census reach cases are presented in the table 300 corresponding to a census reach of 20 percent 302, a census reach of 10 percent 304, and a census reach of one percent 306. In each case, a percentage of the 100,000 users corresponding to the census reach were randomly assigned to have accessed (e.g., been reached by) a given piece of media. A number of users 308 in the table indicates a number of reached or unreached users for each census reach example. For example, in the case of census reach of 20 percent 302, 20,000 of the 100,000 simulated users were assigned to have been reached by the media.

In an example measurement interval, the 100,000 simulated users were randomly assigned to one of 1,000 cohorts, each cohort having 100 users. The cohort assignment process was repeated a total of 10 times resulting in a total of 10,000 cohorts with each user being randomly assigned into one cohort in each iteration. Such a cohort assignment may be subsequently used for one census reach case or for multiple census reach cases. A number of cohorts evaluated 310 in the table 300 indicates a number of cohorts corresponding to a respective number of reached or unreached users. Because each user was assigned to 10 cohorts, the number of cohorts evaluated 310 is ten times greater than the number of users 308 in each example.

For each cohort, a cohort-level reach (e.g., a number of users per cohort that have been reached by the media) is calculated. For each user, an average cohort-level reach is calculated corresponding to an average of the ten cohort-level reaches for the ten cohorts to which the user is assigned. An average cohort-level reach per user 312 in the table 300 indicates an average of the average cohort-level reaches for the reached or unreached users for a given census reach example. For example, in the case of a census reach of 20 percent 302, the average cohort-level reach for the 20,000 reached users is 20.805 and the average cohort-level reach for the 80,000 unreached users is 19.799. For the users known to have been reached, the average cohort-level reach per user is greater than the census reach (e.g., 20). For the users known to have been unreached, the average cohort-level reach per user is less than the census reach (e.g., 20). Therefore, the percentage of times a user's cohorts have a reach greater than an expected reach (e.g., a census reach), the more likely the user was to have been reached by the media.

FIG. 4 is an example bar graph 400 illustrating a distribution of cohorts by cohort-level reach for an example having 20 percent census reach. The data included in the bar graph 400 corresponds to the case of census reach of 20 percent 302 of FIG. 3. In this case, the 100,000 simulated users were randomly assigned to 1,000 cohorts of 100 users a total of 10 iterations, resulting in 10,000 total cohorts. Each of the 10,000 cohorts has a cohort-level reach 402 indicating a number of the 100 users that have been reached by the media. The bar graph 400 illustrates a number of cohorts 404 for each cohort-level reach 402 value of the simulated data. For example, a cohort-level reach of 20 percent 406 was found in 971 of the 10,000 cohorts. In another example, a cohort-level reach of 13 percent 408 was found in 217 of the 10,000 cohorts.

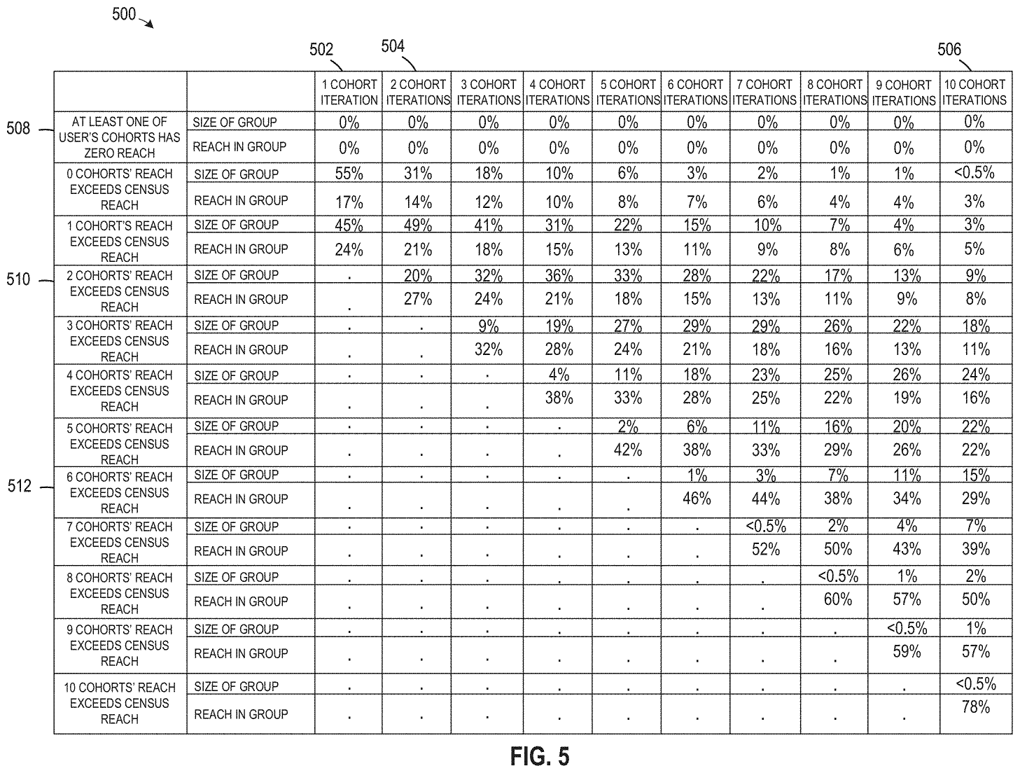

FIG. 5 is an example table 500 illustrating users segmented by a number of the user's cohorts having a reach exceeding the census reach for a plurality of cohort iteration examples. The example table 500 of FIG. 5 illustrates 10 examples where 100,000 users have a census reach of 20 percent. In a first example 502, the 100,000 users are randomly assigned to 1,000 cohorts having 100 users one time. In a second example 504, the 100,000 users are randomly assigned to 1,000 cohorts having 100 users for a total of two iterations. Each subsequent example increases the number of cohort iterations until a last example 506 where the 100,000 users are randomly assigned to 1,000 cohorts having 100 users for a total of ten iterations.

A first data row 508 indicates statistics regarding a number of users for which at least one of the user's cohorts has zero reach. In the example of FIG. 5, for a census reach of 20 percent, none of the cohorts had a cohort-level reach of zero, and, therefore, none of the users had at least one cohort with zero reach. However, in examples with a low census level reach (e.g., 5 percent, 1 percent) it can be anticipated that a number of the cohorts may have a cohort-level reach of zero. Therefore, each of the users in the cohorts having a cohort-level reach of zero are known to have zero reach. Subsequent data rows indicate statistics regarding groups of users where a specific number of the user's cohorts exceeds the census reach (e.g., 20 percent). For example, a second data row 510 corresponds to groups of users where two of the user's cohorts exceeded the census reach. Additionally, a third data row 512 corresponds to groups of users where six of the user's cohorts exceeded the census reach. In the third example 506, 9 percent of users (e.g., 9,000 of the 100,000 users) correspond to the second data row 510 where 2 of the user's 10 cohorts exceeded the census reach. Because the data presented in FIG. 5 is simulated data, reach of the users in the group is known to be 8 percent. Additionally, in the third example 506, 15 percent of users (e.g., 15,000 of the 100,000 users) correspond to the third data row 512 where 6 of the user's 10 cohorts exceeded the census reach. Again, because the data presented in FIG. 5 is simulated data, reach of the users in the group is known to be 29 percent.

The data shown in the example table 500 of FIG. 5 demonstrates a relationship between a number of a user's cohorts exceeding census reach and a likelihood that the user has been reached by a media item. It can be expected that the same relationship would hold if a user's average cohort-level reach were used instead of a number of a user's cohorts exceeding census reach. In other words, there is also a relationship between a user's average cohort-level reach and a user's reach probability. Further, a similar relationship can be assumed for a user's frequency of exposure to a media item and a user's average cohort-level frequency compared to an expected (e.g., census-level) frequency.

FIG. 6 is a graph 600 illustrating example comparisons of cohort-level reach of a first publisher to a second publisher. In the example of FIG. 6, a publisher A has a 10 percent census-reach to an audience of 100,000 users and a publisher B has a 20 percent census-reach to an audience of the same 100,000 users. Three example scenarios are represented in the graph 600 of FIG. 6. In a first example, publisher A and publisher B have fair share duplication (e.g., no relationship between a reach of publisher A and a reach of publisher B). For example, for a media item for a given user, a reach probability for the user for the media item for publisher A has no relationship to a reach probability for the user for the media item for publisher B. In a second example, publisher A and publisher B have duplication exceeding fair share. That is, as reach (e.g., user-level reach probability, census-level reach) increases for publisher A, so does reach for publisher B. Additionally, with duplication exceeding fair share, as reach decreases for publisher A, so does reach for publisher B. In a third example, publisher A and publisher B have duplication lagging fair share. That is, as reach (e.g., user-level reach probability, census-level reach) increases for publisher A, reach decreases for publisher B. Additionally, with duplication lagging fair share, as reach decreases for publisher A, reach increases for publisher B.

In the graph 600 of FIG. 6, the x-axis represents publisher A cohort-level reach 602 for a group of cohorts having the same cohort-level reach while the y-axis represents publisher B median cohort-level reach 604 for those same cohorts. The trend line 606 represents the first example of fair share duplication between publisher A and publisher B. The trend line 608 represents the second example of duplication exceeding fair share between publisher A and publisher B. The trend line 610 represents the third example of duplication lagging fair share between publisher A and publisher B. In the example data represented by the graph 600 of FIG. 6, 311 cohorts have a publisher A cohort-level reach 602 of 5, 1,351 cohorts have a publisher A cohort-level reach 602 of 10, and 346 cohorts have a publisher A cohort-level reach 602 of 15. For the first trend line 606 representing fair share duplication, the 311 cohorts having a publisher A cohort-level reach 602 of 5, the 1,351 cohorts having a publisher A cohort-level reach 602 of 10, and the 346 cohorts having a publisher A cohort-level reach 602 of 15 all have a publisher B median cohort-level reach of 20. In other words, regardless of a publisher A cohort-level reach 602 of a group of cohorts, a publisher B median cohort-level reach 604 for those same cohorts is approximately the census-level reach of publisher B. That is, there is no relationship between the publisher A cohort-level reach 602 and the publisher B median cohort-level reach 604 for the trend line 606 representing fair share duplication. Therefore, the slope of the trend line 606 is zero.

For the second trend line 608 representing duplication exceeding fair share, the 311 cohorts having a publisher A cohort-level reach 602 of 5 have a publisher B median cohort-level reach 604 of approximately 18.7 (e.g., less than the publisher B cohort-level reach), the 1,351 cohorts having a publisher A cohort-level reach 602 of 10 have a publisher B median cohort-level reach 604 of approximately 20 (e.g., the publisher B census-level reach), and the 346 cohorts having a publisher A cohort level reach 602 of 15 have a publisher B median cohort-level reach of approximately 21.3 (e.g., greater than the publisher B census-level reach). In other words, as the publisher A cohort level reach 602 increases, the publisher B median cohort-level reach 604 also increases for the trend line 608 representing duplication exceeding fair share duplication. Therefore, the slope of the trend line 608 is positive.

For the third trend line 610 representing duplication lagging fair share, the 311 cohorts having a publisher A cohort-level reach 602 of 5 have a publisher B median cohort-level reach 604 of approximately 20.6 (e.g., greater than the publisher B cohort-level reach), the 1,351 cohorts having a publisher A cohort-level reach 602 of 10 have a publisher B median cohort-level reach 604 of approximately 20 (e.g., the publisher B census-level reach), and the 346 cohorts having a publisher A cohort level reach 602 of 15 have a publisher B median cohort-level reach of approximately 19.5 (e.g., less than the publisher B census-level reach). In other words, as the publisher A cohort level reach 602 increases, the publisher B median cohort-level reach 604 decreases for the trend line 610 representing duplication lagging fair share duplication. Therefore, the slope of the trend line 610 is negative.

As can be seen by the trend lines 606, 608, and 610 of the graph 600 of FIG. 6, a direction of a slope of a trend line graphing a median cohort-level reach of a second publisher against a cohort-level reach of a first publisher can indicate if the first and the second publisher have fair share duplication, duplication exceeding fair share, or duplication lagging fair share. For example, if the slope of the trend line is zero, the duplication between the first and the second publishers is fair share. If the slope of the trend line is positive, the duplication between the first and the second publishers exceeds fair share duplication. If the slope of the trend line is negative, the duplication between the first and the second publishers lags fair share duplication. Further, a magnitude of a slope of a trend line graphing a median cohort-level reach of a second publisher against a cohort-level reach of a first publisher can indicate a degree to which the first and the second publishers is exceeding or lagging fair share duplication. The direction and magnitude of the slope of the trend line, therefore, indicates a duplication rate between the two publishers. The duplication rate between the two publishers can be applied to individual user's reach probabilities to determine a deduplicated reach probability for the user for a media item.

Flowcharts representative of example hardware logic circuitry, machine readable instructions, hardware implemented state machines, and/or any combination thereof for implementing the audience metrics generator circuitry 122 of FIG. 2 are shown in FIGS. 7-11. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 7-11, many other methods of implementing the example audience metrics generator circuitry 122 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-11 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to estimate user-level media impressions. The machine readable instructions and/or the operations 700 of FIG. 7 begin at block 702, at which the example network interface circuitry 202 (FIG. 2) accesses cohort-level impression data corresponding to accesses to media via a plurality of client devices. At block 704, the example statistics generator circuitry 210 (FIG. 2) determines average cohort-level reach for ones of a plurality of users corresponding to the client devices. At block 706, the example metrics calculator circuitry 212 (FIG. 2) determines a reach probability for a first user based on the average cohort-level reach for the first user and a census-level reach of the cohort-level impression data. At block 708, the example reporter circuitry 206 (FIG. 2) generates a report including the reach probability for the first user. The process of FIG. 7 ends.

FIG. 8 is a flowchart representative of example machine readable instructions and/or example operations 800 that may be executed and/or instantiated by processor circuitry to estimate user-level media impressions and/or frequency. The machine readable instructions and/or the operations 800 of FIG. 8 begin at block 802, at which the example cohort management circuitry 208 (FIG. 2) assigns users to cohorts. For example, the cohort management circuitry 208 retrieves the user IDs 124 (FIG. 1) from the census-level database 120 (FIG. 1) and assigns each of the user IDs 124 randomly into a plurality of cohorts (e.g., 1,000 cohorts) of the same size (e.g., 100 users) for a plurality of iterations (e.g., 10). As a result of the operations of block 802, the cohort management circuitry 208 generates user ID-to-cohort assignments for each user ID corresponding to the number of iterations. In some examples, the cohort management circuitry 208 stores the user ID-to-cohort assignments in the audience metrics data storage 204 (FIG. 2). At block 804, the example network interface circuitry 202 (FIG. 2) accesses cohort-level impression data from a database proprietor (e.g., the database proprietor 110 of FIG. 1). For example, the network interface circuitry 202 can send a cohort data request 130 (FIG. 1) to a database proprietor 110 (FIG. 1) including the user ID-to-cohort assignments generated by the example cohort management circuitry 208. The example database proprietor 110 responds by sending the cohort-level impression data 132.

At block 806, the example statistics generator circuitry 210 (FIG. 2) determines a census-level reach or frequency for the cohort-level impression data. For example, based on the cohort-level reach of each of the cohorts included in the cohort-level impression data 132 and a known size of the cohorts, the statistics generator circuitry 210 determines a census-level reach for the cohort-level impression data 132. In some examples, the cohort-level impression data 132 includes cohort-level frequency data and the statistics generator circuitry 210 determines a census-level frequency for the cohort-level impression data 132. The example statistics generator circuitry 210 can store the census-level reach and/or the census-level frequency in the audience metrics data storage 204.

At block 808, the example statistics generator circuitry 210 determines an average cohort-level reach or frequency for each user included in the cohort-level impression data. For example, for each user, the statistics generator circuitry 210 uses the user ID-to-cohort assignments to determine which cohorts the user was assigned to. The example statistics generator circuitry 210 retrieves the cohort-level reach of each of the cohorts for which the user was assigned to from the cohort-level impression data 132 and determines an average of those cohort-level reaches. Such a process is repeated for each user to determine the average cohort-level reach for each user. In some examples, the cohort-level impression data 132 includes cohort-level frequency data and the statistics generator circuitry determines an average cohort-level frequency for each user based on the cohort-level impression data 132 and the user ID-to-cohort assignments.

At block 810, the example metrics calculator circuitry 212 (FIG. 2) determines a reach or frequency probability for each of the user IDs included in the cohort-level impression data. For example, for each user, the metrics calculator circuitry 212 uses a comparison of the average cohort-level reach determined by the statistics generator circuitry 210 and an expected reach value (e.g., the census-level reach of the cohort-level impression data 132) to determine a user-level reach probability. In some examples, the metrics calculator circuitry 212 compares an average cohort-level frequency to an expected frequency value (e.g., the census-level frequency of the cohort-level impression data 132) to determine a user-level frequency probability. Such a process is repeated for each user to determine a user-level reach probability or frequency probability for each user. At block 812, the example reporter circuitry 206 (FIG. 2) compiles the user-level reach or frequency probabilities into an audience metrics table. For example, the reporter circuitry 206 can generate a table including each user ID and the user-level reach or frequency probability for that user ID calculated by the metrics calculator circuitry 212. In some examples, the reporter circuitry 206 stores the audience metrics table including the user-level reach or frequency probabilities in the audience metrics data storage 204. At block 814, the example reporter circuitry 206 outputs the audience metrics table to a customer (e.g., the customer 114 of FIG. 1). The process of FIG. 8 ends.

FIG. 9 is a flowchart representative of example machine readable instructions and/or example operations 900 that may be executed and/or instantiated by processor circuitry to determine user-level deduplicated reach probabilities. The machine readable instructions and/or the operations 900 of FIG. 9 begin at block 902, at which the example network interface circuitry 202 (FIG. 2) accesses first cohort-level impression data and second cohort-level impression data corresponding to accesses to media via a plurality of devices. At block 902, the first cohort-level impression data is from a first publisher, and the second cohort-level impression data is from a second publisher. At block 904, the example statistics generator circuitry 210 (FIG. 2) determines a duplication probability between the first publisher and the second publisher based on the first cohort-level impression data and the second cohort-level impression data. At block 906, the example metrics calculator circuitry 212 (FIG. 2) determines a deduplicated reach probability for a first user based on the duplication probability. At block 908, the example reporter circuitry 206 (FIG. 2) generates a report including the deduplicated reach probability for the first user. The process of FIG. 9 ends.

FIG. 10 is a flowchart representative of example machine readable instructions and/or example operations 1000 that may be executed and/or instantiated by processor circuitry to determine user-level deduplicated reach probabilities. The machine readable instructions and/or the operations 1000 of FIG. 10 begin at block 1002, at which the example cohort-management circuitry 208 (FIG. 2) assigns users to cohorts. For example, the cohort management circuitry 208 retrieves the user IDs 124 (FIG. 1) from the census-level database 120 (FIG. 1) and assigns each of the user IDs 124 randomly into a plurality of cohorts (e.g., 1,000 cohorts) of the same size (e.g., 100 users) for a plurality of iterations (e.g., 10). In some examples, the cohort-management circuitry 208 selects a subset of the user IDs 124 that are known to be subscribers to both a first database proprietor and a second database proprietor. Thus, the cohort assignments can be syndicated between the multiple database proprietors. As a result of the operations of block 1002, the cohort management circuitry 208 generates user ID-to-cohort assignments for each user ID corresponding to the number of iterations. In some examples, the cohort management circuitry 208 stores the user ID-to-cohort assignments in the audience metrics data storage 204 (FIG. 2).

At block 1004, the example network interface circuitry 202 (FIG. 2) requests cohort-level impression data from a first database proprietor and a second database proprietor. For example, the network interface circuitry 202 can send a cohort data request 130 (FIG. 1) to the first database proprietor including the user ID-to-cohort assignments generated by the example cohort management circuitry 208. The example network interface circuitry 202 additionally sends a cohort data request 130 to the second database proprietor including the same user ID-to-cohort assignments. The first database proprietor responds by sending first cohort-level impression data and the second database proprietor responds by sending second cohort-level impression data.

At block 1006, the example audience metrics generator circuitry 122 (FIG. 1) determines reach probabilities for each user ID for each database proprietor. Example instructions that may be used to implement the determining of reach probabilities of block 1006 are discussed above in connection with blocks 806, 808, 810, and 812 of FIG. 8. The instructions of blocks 806, 808, 810, and 812 can be repeated by the audience metrics generator circuitry 122 for the first cohort-level impression data from the first database proprietor and the second cohort-level impression data from the second database proprietor. As a result of the operations of block 1006, the example audience metrics generator circuitry 122 stores audience metrics including the user-level reach probabilities for the first database proprietor and the second database proprietor in the audience metrics data storage 204 (FIG. 4). At block 1008, the example statistics generator circuitry 210 (FIG. 2) determines a distribution of cohorts by cohort-level reach for the first database proprietor. For example, the statistics generator circuitry 210 can determine a number of cohorts from the first cohort-level impression data having each possible cohort level reach (e.g., from 0 to a size of the cohort). The example statistics generator circuitry 210 can record the number of and which cohorts had each possible cohort-level reach within the first cohort-level impression data.

At block 1010, the example graph generator circuitry 214 (FIG. 2) generates a duplication plot for the first database proprietor and the second database proprietor. Example instructions that may be used to implement the operations of block 1010 are discussed below in connection with FIG. 11. As a result of the operations of block 1010, the example graph generator circuitry 214 determines and stores information (e.g., an equation) about the trendline. At block 1012, the example statistics generator circuitry 210 determines a duplication probability for the first database proprietor and the second database proprietor based on the plot. For example, based on the value of the slope of the trendline determined by the graph generator circuitry 214, the statistics generator circuitry 210 can determine the duplication probability between the first database proprietor and the second database proprietor as a function of fair share duplication (e.g., same as fair share duplication, twice fair share duplication, half of fair share duplication, etc.)

At block 1014, the example metrics calculator circuitry 212 (FIG. 2) applies the duplication probability to each user ID included in the impression data to determine deduplicated reach probabilities for each user ID. For example, based on the reach probabilities for each user for the first database proprietor and the second database proprietor determined at block 1006 and the duplication probability determined by the statistics generator circuitry 210 at block 1012, the metrics calculator circuitry can determine a deduplicated reach probability for each user ID. At block 1016, the example reporter circuitry 206 (FIG. 2) compiles the deduplicated reach probabilities into an audience metrics table. For example, the reporter circuitry 206 can generate a table including each user ID, the user-level reach probability for that user ID for the first database proprietor, the user-level reach probability for that user ID for the second database proprietor, and the deduplicated reach probability for that user ID. In some examples, the reporter circuitry 206 stores the audience metrics table including the deduplicated user-level reach probabilities in the audience metrics data storage 204. At block 1018, the example reporter circuitry 206 outputs the audience metrics table to a customer (e.g., the customer 114 of FIG. 1). The process of FIG. 10 ends.

FIG. 11 is a flowchart representative of example machine readable instructions and/or example operations 1010 that may be executed and/or instantiated by processor circuitry to generate a duplication plot. The machine readable instructions and/or the operations 1010 of FIG. 11 begin at block 1102, at which the example graph generator circuitry 214 (FIG. 2) determines median cohort-level reaches for the second database proprietor based on the distribution of cohorts determined for the first database proprietor. For example, for each possible cohort-level reach value (e.g., 0 to 100 for cohorts having a size of 100), the statistics generator circuitry 210 determined which cohorts had each possible cohort-level reach value for the first database proprietor. The example graph generator circuitry 214 can then, for each possible cohort-level reach value, determine the cohort-level reach for those cohorts for the second database proprietor and determine a median cohort-level reach of those cohorts.

At block 1104, the example graph generator circuitry 214 generates a scatter plot (e.g., an X-Y scatter plot) of the median cohort-level reaches for the second database proprietor as a function of the cohort-level reach for the first database proprietor. For example, the graph generator circuitry 214 can plot datapoints with an X-value corresponding to each possible cohort-level reach value and a Y-value corresponding to the median cohort-level reaches for the second database proprietor as determined at block 1102. At block 1106, the example graph generator circuitry 214 determines a trendline for the scatter plot. For example, the graph generator circuitry 214 can determine a line of best fit for the datapoints using regression analysis. As a result, the graph generator circuitry 214 determines an equation corresponding to the line of best fit. At block 1108, the example graph generator circuitry 214 stores information corresponding to the trendline. For example, the graph generator circuitry 214 stores the equation of the line of best fit including a slope of the line. The process of FIG. 11 ends.

FIG. 12 is a block diagram of an example processor platform 1200 structured to execute and/or instantiate the machine readable instructions and/or the operations of FIGS. 7-11 to implement the audience metrics generator circuitry 122 of FIG. 2. The processor platform 1200 can be, for example, a server, a personal computer, a workstation, a self-learning machine (e.g., a neural network), or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements the audience metrics generator circuitry 122, the network interface circuitry 202, the reporter circuitry 206, the cohort management circuitry 208, the statistics generator circuitry 210, the metrics calculator circuitry 212, and the graph generator circuitry 214.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1232, which may be implemented by the machine readable instructions of FIGS. 7-11, may be stored in the mass storage device 1228, in the volatile memory 1214, in the non-volatile memory 1216, and/or on a removable non-transitory computer readable storage medium such as a CD or DVD.

FIG. 13 is a block diagram of an example implementation of the processor circuitry 1312 of FIG. 12. In this example, the processor circuitry 1212 of FIG. 12 is implemented by a microprocessor 1300. For example, the microprocessor 1300 may be a general purpose microprocessor (e.g., general purpose microprocessor circuitry). The microprocessor 1300 executes some or all of the machine readable instructions of the flowcharts of FIGS. 7-11 to effectively instantiate the circuitry of FIG. 2 as logic circuits to perform the operations corresponding to those machine readable instructions. In some such examples, the circuitry of FIG. 2 is instantiated by the hardware circuits of the microprocessor 1300 in combination with the instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 7-11.

The cores 1302 may communicate by a first example bus 1304. In some examples, the first bus 1304 may be implemented by a communication bus to effectuate communication associated with one(s) of the cores 1302. For example, the first bus 1304 may by implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2_ cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 14 is a block diagram of another example implementation of the processor circuitry 1212 of FIG. 12. In this example, the processor circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 7-11 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowcharts of FIGS. 7-11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowcharts of FIGS. 7-11. As such, the FPGA circuitry 1400 may be structured to effectively instantiate some or all of the machine readable instructions of the flowcharts of FIGS. 7-11 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 7-11 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may be implemented by external hardware circuitry. For example, the external hardware 1406 may be implemented by the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations that may correspond to at least some of the machine readable instructions of FIGS. 7-11 and/or other desired operations. The logic gate circuitry 1408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1212 of FIG. 12, many other approaches are contemplated. For example, as mentioned above, modern FPGA circuitry may include an on-board CPU, such as one or more of the example CPU 1420 of FIG. 14. Therefore, the processor circuitry 1212 of FIG. 12 may additionally be implemented by combining the example microprocessor 1300 of FIG. 13 and the example FPGA circuitry 1400 of FIG. 14. In some such hybrid examples, a first portion of the machine readable instructions represented by the flowcharts of FIGS. 7-11 may be executed by one or more of the cores 1302 of FIG. 13, a second portion of the machine readable instructions represented by the flowcharts of FIGS. 7-11 may be executed by the FPGA circuitry 1400 of FIG. 14, and/or a third portion of the machine readable instructions represented by the flowcharts of FIGS. 7-11 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the processor circuitry 1212 of FIG. 12, which may be in one or more packages. For example, the XPU may include a CPU in one package, a DSP in another package, a GPU in yet another package, and an FPGA in still yet another package.

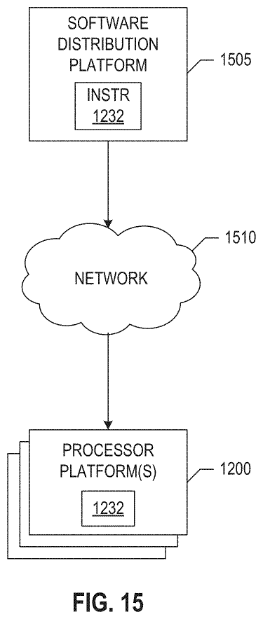

A block diagram illustrating an example software distribution platform 1505 to distribute software such as the example machine readable instructions 1232 of FIG. 12 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions 700, 800, 900, 1000, 1010 of FIGS. 7-11, as described above. The one or more servers of the example software distribution platform 1505 are in communication with an example network 1510, which may correspond to any one or more of the Internet and/or any of the example networks 108 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions 700, 800, 900, 1000, 1010 of FIGS. 7-11, may be downloaded to the example processor platform 1200, which is to execute the machine readable instructions 1232 to implement the audience metrics generator circuitry 122. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices.

From the foregoing, it will be appreciated that example systems, methods, apparatus, and articles of manufacture have been disclosed that estimate audience metrics (e.g., audience reach and/or audience frequency) and duplication from the impressions using cohorts. Disclosed systems, methods, apparatus, and articles of manufacture improve the efficiency of using a computing device by estimating user-level audience metrics without the use of tags (e.g., monitoring instructions embedded in media) or third-party cookies. As such, the complex network communications needed to determine user-level metrics using tags and/or cookies are not needed. Additionally, examples disclosed herein can accurately estimate user-level audience metrics using reduced cohort iterations. Examples disclosed herein generate reduced cohort iterations by using aggregated cohort metrics in lieu of census-level metrics. As such, network communications related to requesting and transmitting cohort-level impression data can be reduced. Disclosed systems, methods, apparatus, and articles of manufacture are accordingly directed to one or more improvement(s) in the operation of a machine such as a computer or other electronic and/or mechanical device. In addition, examples disclosed herein improve the accuracy of computer-generated audience metrics by syndicating cohorts across database proprietors, and transmitting such cohort syndications across one or more networks to those database proprietors. As such examples disclosed herein use network-distributed cohort syndications to improve the accuracy of computer-generated audience metrics.

Example methods, apparatus, systems, and articles of manufacture for estimating media impressions and duplication using cohorts are disclosed herein. Further examples and combinations thereof include the following:

Example 1 includes an apparatus including at least one memory, instructions in the apparatus, and processor circuitry to execute the instructions to access cohort-level impression data corresponding to accesses to media via a plurality of client devices, determine an average cohort-level reach for ones of a plurality of users corresponding to the client devices, determine a reach probability for a first user of the plurality of users based on the average cohort-level reach for the first user and a census-level reach, and generate a report including the reach probability for the first user.

Example 2 includes the apparatus of example 1, wherein the cohort-level impression data includes at least a first cohort iteration and a second cohort iteration.

Example 3 includes the apparatus of example 2, wherein the average cohort-level reach for the ones of the plurality of users is an average of a first cohort-level reach for the first cohort iteration and a second cohort-level reach for the second cohort iteration.

Example 4 includes the apparatus of example 3, wherein the processor circuitry is to determine the reach probability for the first user is zero if at least one of the first cohort-level reach for the first cohort iteration or the second cohort-level reach for the second cohort iteration is zero.

Example 5 includes the apparatus of example 1, wherein the processor circuitry is to determine the reach probability based on a comparison of the average cohort-level reach for the first user and the census-level reach.

Example 6 includes the apparatus of example 1, wherein the cohort-level impression data corresponds to a cohort that includes a portion of the plurality of users.

Example 7 includes the apparatus of example 6, wherein the portion of the plurality of users includes a number of the plurality of users randomly assigned to the cohort.

Example 8 includes the apparatus of example 1, wherein the cohort-level impression data includes cohort-level reaches for corresponding cohorts.

Example 9 includes the apparatus of example 1, wherein the processor circuitry is to determine an average cohort-level frequency for the ones of the plurality of users corresponding to the client devices, determine an estimated frequency for the first user of the plurality of users based on the average cohort-level frequency for the first user and a census-level frequency, and include the estimated frequency for the first user in the report.

Example 10 includes at least one non-transitory computer readable storage medium including instructions that, when executed, cause at least one processor to at least access cohort-level impression data corresponding to accesses to media via a plurality of client devices, determine an average cohort-level reach for ones of a plurality of users corresponding to the client devices, determine a reach probability for a first user of the plurality of users based on the average cohort-level reach for the first user and a census-level reach, and generate a report including the reach probability for the first user.

Example 11 includes the at least one non-transitory computer readable storage medium of example 10, wherein the cohort-level impression data includes at least a first cohort iteration and a second cohort iteration.

Example 12 includes the at least one non-transitory computer readable storage medium of example 11, wherein the average cohort-level reach for the ones of the plurality of users is an average of a first cohort-level reach for the first cohort iteration and a second cohort-level reach for the second cohort iteration.

Example 13 includes the at least one non-transitory computer readable storage medium of example 12, wherein the instructions cause the at least one processor to determine the reach probability for the first user is zero if at least one of the first cohort-level reach for the first cohort iteration or the second cohort-level reach for the second cohort iteration is zero.

Example 14 includes the at least one non-transitory computer readable storage medium of example 10, wherein the instructions cause the at least one processor to determine the reach probability based on a comparison of the average cohort-level reach for the first user and the census-level reach.

Example 15 includes the at least one non-transitory computer readable storage medium of example 10, wherein the cohort-level impression data corresponds to a cohort that includes a portion of the plurality of users.

Example 16 includes the at least one non-transitory computer readable storage medium of example 15, wherein the portion of the plurality of users includes a number of the plurality of users randomly assigned to the cohort.

Example 17 includes the at least one non-transitory computer readable storage medium of example 10, wherein the cohort-level impression data includes cohort-level reaches for corresponding cohorts.

Example 18 includes the at least one non-transitory computer readable storage medium of example 10, wherein the instructions cause the at least one processor to determine an average cohort-level frequency for the ones of the plurality of users corresponding to the client devices, determine an estimated frequency for the first user of the plurality of users based on the average cohort-level frequency for the first user and a census-level frequency, and include the estimated frequency for the first user in the report.

Example 19 includes a method including accessing, by executing an instruction with at least one processor, cohort-level impression data corresponding to accesses to media via a plurality of client devices, determining, by executing an instruction with the at least one processor, an average cohort-level reach for ones of a plurality of users corresponding to the client devices, determining, by executing an instruction with the at least one processor, a reach probability for a first user of the plurality of users based on the average cohort-level reach for the first user and a census-level reach, and generating, by executing an instruction with the at least one processor, a report including the reach probability for the first user.

Example 20 includes the method of example 19, wherein the cohort-level impression data includes at least a first cohort iteration and a second cohort iteration.

Example 21 includes the method of example 20, wherein the average cohort-level reach for the ones of the plurality of users is an average of a first cohort-level reach for the first cohort iteration and a second cohort-level reach for the second cohort iteration.

Example 22 includes the method of example 21, further including determining, by executing an instruction with the at least one processor, the reach probability for the first user is zero if at least one of the first cohort-level reach for the first cohort iteration or the second cohort-level reach for the second cohort iteration is zero.

Example 23 includes the method of example 19, further including determining, by executing an instruction with the at least one processor, the reach probability based on a comparison of the average cohort-level reach for the first user and the census-level reach.

Example 24 includes the method of example 19, wherein the cohort-level impression data corresponds to a cohort that includes a portion of the plurality of users.

Example 25 includes the method of example 24, wherein the portion of the plurality of users includes a number of the plurality of users randomly assigned to the cohort.

Example 26 includes the method of example 19, wherein the cohort-level impression data includes cohort-level reaches for corresponding cohorts.

Example 27 includes the method of example 19, further including determining an average cohort-level frequency for the ones of the plurality of users corresponding to the client devices, determining an estimated frequency for the first user of the plurality of users based on the average cohort-level frequency for the first user and a census-level frequency, and including the estimated frequency for the first user in the report.

Example 28 includes an apparatus including at least one memory, instructions in the apparatus, and processor circuitry to execute the instructions to access first cohort-level impression data and second cohort-level impression data corresponding to accesses to media via a plurality of devices, the first cohort-level impression data from a first publisher, the second cohort-level impression data from a second publisher, determine a duplication probability between the first publisher and the second publisher based on the first cohort-level impression data and the second cohort-level impression data, determine a deduplicated reach probability for a first user based on the duplication probability, and generate a report including the deduplicated reach probability for the first user.

Example 29 includes the apparatus of example 28, wherein a portion of a plurality of users corresponding to the plurality of devices are randomly assigned to a cohort.

Example 30 includes the apparatus of example 28, wherein the processor circuitry is to determine a first distribution of cohorts by cohort-level reach for the first publisher and a second distribution of cohorts by cohort-level reach for the second publisher.

Example 31 includes the apparatus of example 30, wherein the processor circuitry is to determine the duplication probability based on a comparison of the first distribution of cohorts and the second distribution of cohorts.

Example 32 includes the apparatus of example 31, wherein the comparison of the first distribution of cohorts and the second distribution of cohorts generates a trend line.

Example 33 includes the apparatus of example 32, wherein processor circuitry is to determine the duplication probability as greater than a fair share duplication if a slope of the trend line is positive or determine the duplication probability as less than a fair share duplication if the slope of the trend line is negative.

Example 34 includes the apparatus of example 28, wherein the processor circuitry is to determine a first reach probability for the first user for the first publisher based on the first cohort-level impression data, and determine a second reach probability for the first user for the second publisher based on the second cohort-level impression data.

Example 35 includes the apparatus of example 34, wherein the processor circuitry is to determine the deduplicated reach probability for the first user based on the first reach probability, the second reach probability, and the duplication probability.

Example 36 includes the apparatus of example 28, wherein the processor circuitry is to assign users to multiple cohorts, syndicate the cohorts across the first publisher and the second publisher by causing a network-based transmission of the cohorts to the first publisher and the second publisher, request syndicated cohort-level impression data from the first publisher and the second publisher, and determine the duplication probability based on the syndicated cohort-level impression data.

Example 37 includes the apparatus of example 28, wherein the processor circuitry is to determine the deduplicated reach probability based on the duplication probability and a reach probability for a plurality of users.

Example 38 includes at least one non-transitory computer readable storage medium including instructions that, when executed, cause at least one processor to at least access first cohort-level impression data and second cohort-level impression data corresponding to accesses to media via a plurality of devices, the first cohort-level impression data from a first publisher, the second cohort-level impression data from a second publisher, determine a duplication probability between the first publisher and the second publisher based on the first cohort-level impression data and the second cohort-level impression data, determine a deduplicated reach probability for a first user based on the duplication probability, and generate a report including the deduplicated reach probability for the first user.

Example 39 includes the at least one non-transitory computer readable storage medium of example 38, wherein a portion of a plurality of users corresponding to the plurality of devices are randomly assigned to a cohort.

Example 40 includes the at least one non-transitory computer readable storage medium of example 38, wherein the instructions cause the at least one processor to determine a first distribution of cohorts by cohort-level reach for the first publisher and a second distribution of cohorts by cohort-level reach for the second publisher.

Example 41 includes the at least one non-transitory computer readable storage medium of example 40, wherein the instructions cause the at least one processor to determine the duplication probability based on a comparison of the first distribution of cohorts and the second distribution of cohorts.

Example 42 includes the at least one non-transitory computer readable storage medium of example 41, wherein the comparison of the first distribution of cohorts and the second distribution of cohorts generates a trend line.

Example 43 includes the at least one non-transitory computer readable storage medium of example 42, wherein the instructions cause the at least one processor to determine the duplication probability as greater than a fair share duplication if a slope of the trend line is positive or determine the duplication probability as less than a fair share duplication if the slope of the trend line is negative.

Example 44 includes the at least one non-transitory computer readable storage medium of example 38, wherein the instructions cause the at least one processor to determine a first reach probability for the first user for the first publisher based on the first cohort-level impression data, and determine a second reach probability for the first user for the second publisher based on the second cohort-level impression data.

Example 45 includes the at least one non-transitory computer readable storage medium of example 44, wherein the instructions cause the at least one processor to determine the deduplicated reach probability for the first user based on the first reach probability, the second reach probability, and the duplication probability.

Example 46 includes the at least one non-transitory computer readable storage medium of example 38, wherein the instructions cause the at least one processor to assign users to multiple cohorts, syndicate the cohorts across the first publisher and the second publisher by causing a network-based transmission of the cohorts to the first publisher and the second publisher, request syndicated cohort-level impression data from the first publisher and the second publisher, and determine the duplication probability based on the syndicated cohort-level impression data.

Example 47 includes the at least one non-transitory computer readable storage medium of example 38, wherein the instructions cause the at least one processor to determine the deduplicated reach probability by combining the duplication probability and a reach probability for a plurality of users.

Example 48 includes a method including accessing, by executing an instruction with at least one processor, first cohort-level impression data and second cohort-level impression data corresponding to accesses to media via a plurality of devices, the first cohort-level impression data from a first publisher, the second cohort-level impression data from a second publisher, determining, by executing an instruction with the at least one processor, a duplication probability between the first publisher and the second publisher based on the first cohort-level impression data and the second cohort-level impression data, determining, by executing an instruction with the at least one processor, a deduplicated reach probability for a first user based on the duplication probability, and generating, by executing an instruction with the at least one processor, a report including the deduplicated reach probability for the first user.

Example 49 includes the method of example 48, wherein a portion of a plurality of users corresponding to the plurality of devices are randomly assigned to a cohort.

Example 50 includes the method of example 48, further including determining a first distribution of cohorts by cohort-level reach for the first publisher and a second distribution of cohorts by cohort-level reach for the second publisher.

Example 51 includes the method of example 50, further including determining the duplication probability based on a comparison of the first distribution of cohorts and the second distribution of cohorts.

Example 52 includes the method of example 51, wherein the comparison of the first distribution of cohorts and the second distribution of cohorts generates a trend line.

Example 53 includes the method of example 52, further including determining the duplication probability as greater than a fair share duplication if a slope of the trend line is positive or determine the duplication probability as less than a fair share duplication if the slope of the trend line is negative.

Example 54 includes the method of example 48, further including determining a first reach probability for the first user for the first publisher based on the first cohort-level impression data, and determining, with the at least one processor, a second reach probability for the first user for the second publisher based on the second cohort-level impression data.

Example 55 includes the method of example 54, further including determining the deduplicated reach probability for the first user based on the first reach probability, the second reach probability, and the duplication probability.

Example 56 includes the method of example 48, further including assigning users to multiple cohorts, syndicating the cohorts across the first publisher and the second publisher by causing network-based transmission of the cohorts to the first publisher and the second publisher, requesting syndicated cohort-level impression data from the first publisher and the second publisher, and determining the duplication probability based on the syndicated cohort-level impression data.

Example 57 includes the method of example 48, further including determining the deduplicated reach probability by combining the duplication probability and a reach probability for a plurality of users.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
instructions in the apparatus; and
processor circuitry to execute the instructions to:
access cohort-level impression data corresponding to accesses to media via a plurality of client devices;
determine an average cohort-level reach for ones of a plurality of users corresponding to the client devices;
determine a reach probability for a first user of the plurality of users based on the average cohort-level reach for the first user and a census-level reach; and
generate a report including the reach probability for the first user.

2. The apparatus of claim 1, wherein the cohort-level impression data includes at least a first cohort iteration and a second cohort iteration.

3. The apparatus of claim 2, wherein the average cohort-level reach for the ones of the plurality of users is an average of a first cohort-level reach for the first cohort iteration and a second cohort-level reach for the second cohort iteration.

4. The apparatus of claim 3, wherein the processor circuitry is to determine the reach probability for the first user is zero if at least one of the first cohort-level reach for the first cohort iteration or the second cohort-level reach for the second cohort iteration is zero.

5. The apparatus of claim 1, wherein the processor circuitry is to determine the reach probability based on a comparison of the average cohort-level reach for the first user and the census-level reach.

6. The apparatus of claim 1, wherein the cohort-level impression data corresponds to a cohort that includes a portion of the plurality of users.

7. The apparatus of claim 6, wherein the portion of the plurality of users includes a number of the plurality of users randomly assigned to the cohort.

8. The apparatus of claim 1, wherein the cohort-level impression data includes cohort-level reaches for corresponding cohorts.

9. The apparatus of claim 1, wherein the processor circuitry is to:
determine an average cohort-level frequency for the ones of the plurality of users corresponding to the client devices;
determine an estimated frequency for the first user of the plurality of users based on the average cohort-level frequency for the first user and a census-level frequency; and
include the estimated frequency for the first user in the report.

10. At least one non-transitory computer readable storage medium comprising instructions that, when executed, cause at least one processor to at least:
access cohort-level impression data corresponding to accesses to media via a plurality of client devices;
determine an average cohort-level reach for ones of a plurality of users corresponding to the client devices;
determine a reach probability for a first user of the plurality of users based on the average cohort-level reach for the first user and a census-level reach; and
generate a report including the reach probability for the first user.

11. The at least one non-transitory computer readable storage medium of claim 10, wherein the cohort-level impression data includes at least a first cohort iteration and a second cohort iteration.

12-27. (canceled)

28. An apparatus comprising:
at least one memory;
instructions in the apparatus; and
processor circuitry to execute the instructions to:
access first cohort-level impression data and second cohort-level impression data corresponding to accesses to media via a plurality of devices, the first cohort-level impression data from a first publisher, the second cohort-level impression data from a second publisher;
determine a duplication probability between the first publisher and the second publisher based on the first cohort-level impression data and the second cohort-level impression data;
determine a deduplicated reach probability for a first user based on the duplication probability; and
generate a report including the deduplicated reach probability for the first user.

29. The apparatus of claim 28, wherein a portion of a plurality of users corresponding to the plurality of devices are randomly assigned to a cohort.

30. The apparatus of claim 28, wherein the processor circuitry is to determine a first distribution of cohorts by cohort-level reach for the first publisher and a second distribution of cohorts by cohort-level reach for the second publisher.

31. The apparatus of claim 30, wherein the processor circuitry is to determine the duplication probability based on a comparison of the first distribution of cohorts and the second distribution of cohorts.

32. The apparatus of claim 31, wherein the comparison of the first distribution of cohorts and the second distribution of cohorts generates a trend line.

33. The apparatus of claim 32, wherein processor circuitry is to determine the duplication probability as greater than a fair share duplication if a slope of the trend line is positive or determine the duplication probability as less than a fair share duplication if the slope of the trend line is negative.

34. The apparatus of claim 28, wherein the processor circuitry is to:
determine a first reach probability for the first user for the first publisher based on the first cohort-level impression data; and
determine a second reach probability for the first user for the second publisher based on the second cohort-level impression data.

35. The apparatus of claim 34, wherein the processor circuitry is to determine the deduplicated reach probability for the first user based on the first reach probability, the second reach probability, and the duplication probability.

36. The apparatus of claim 28, wherein the processor circuitry is to:
assign users to multiple cohorts;
syndicate the cohorts across the first publisher and the second publisher by causing a network-based transmission of the cohorts to the first publisher and the second publisher;
request syndicated cohort-level impression data from the first publisher and the second publisher; and
determine the duplication probability based on the syndicated cohort-level impression data.

37. The apparatus of claim 28, wherein the processor circuitry is to determine the deduplicated reach probability based on the duplication probability and a reach probability for a plurality of users.

38-57. (canceled)
